(19) United States
(12) Patent Application Publication
(10) Pub. No.: US 2023/0128656 A1
(43) Pub. Date: Apr. 27, 2023

(54) 3D MODELLING AND REPRESENTATION OF FURNISHED ROOMS AND THEIR MANIPULATION

(71) Applicant: Simply Innovation GmbH, Krefeld (DE)

(72) Inventor: David Hussey, Krefeld (DE)

(21) Appl. No.: 17/914,750

(22) PCT Filed: Mar. 17, 2021
(86) PCT No.: PCT/EP2021/056797

§ 371 Date: Sep. 26, 2022

(30) Foreign Application Priority Data
Mar. 25, 2020 (EP) 20165713.7
Jul. 3, 2020 (EP) 20184089.9
Mar. 5, 2021 (EP) 21161041.5

(51) Int. Cl. G06T 19/20

(52) U.S. Cl. CPC G06T 19/20; G06T 2219/2004; G06T 2210/04

(57) ABSTRACT

A computer implemented method for producing a visualisation, comprising the steps of
a. obtaining
   i. a first element set, wherein the first element set has a first volume,
   ii. a second element set, wherein the second element set has a second volume;
b. displaying
   i. a primary representation of a three-dimensional space,
   ii. the first element set at a first position in the primary representation,
   iii. displaying the second element set at a second position in the primary representation, wherein a distance between the first position and the second position has a first length;
c. moving the first element set from the first position to a further position in the primary representation, wherein
   i. the moving of the first element set causes the second element set to move from the second position to an even-further position in the primary representation,
   ii. the distance between the further position and the even-further position has a further length, wherein the first length and the further length vary with less than 5% with respect to each other,
   iii. wherein less than 5% of the first volume overlaps with the second volume.

### FIELD OF THE INVENTION

In general, the invention pertains to a computer implemented method for the visualisation of three-dimensional items. In particular, the invention pertains to the three-dimensional modelling and visualisation of furnished rooms. The invention further pertains to a manipulation of said visualisation. The invention also pertains to a method for producing furniture using said visualisation.

### BACKGROUND

A person, such as an interior designer or customer, who is interested in placing at least one first item of furniture in a room generally want to see a visualisation of the at least one first item of furniture in the room. This is important for e.g., planning purposes, such as deciding on a location of the at least one first item of furniture. The visualisation is also important for e.g. production purposes, such as determining what the dimensions, e.g., a length and a height, should be of the at least one first item of furniture that is to be produced. This becomes even more important if the room further comprises at least one second item of furniture.

While software is available for producing a visualisation of a three-dimensional, furnished room, this software has numerous drawbacks. These drawbacks include limited functionality, such as a fixed viewing angle for the visualisation, requiring a long time to generate the visualisation, usually often more than 15 min, or requiring that a human operator using the software has to switch between the visualisation and a floor plan of the room being visualised. This switching has to be done every time a change in the visualisation, such as replacing a furniture item, is made.

E.g., the room should consist of a first dining room table and six dining room chairs arranged around the first dining room table. The software provides a.) a floor plan of the room; b.) a representation of the first dining room table, defined as a first element set consisting of one first element and c.) six representations of the dining room chairs, defined as a second element set consisting of six second elements. The first element, as well as every second element, have to be arranged individually, i.e., one at a time, on the floor plan. Next, the viewing angle is chosen. Using the floor plan and the viewing angle, the visualisation is generated. If the human operator decides that the first dining room table should be replaced by a larger, second dining room table, one has to switch back to the floor plan. The first element set is updated in order to represent the second dining room table in the floor plan. This often leads to the problem that the first element at least partially covers one or more second elements in the floor plan. This has a negative impact on the correct and quick comprehension of the visualisation by a viewer. In particular, the correct relation of at least two items of furniture, often having rather different colours, designs and sites, to each other in the floor plan suffers. Therefore, many of the second elements have to be corrected by individually re-arranging it around the first element in several steps. Once these several steps have been completed, the visualisation has to be re-generated again in at least one further step.

Not only is the above procedure for producing the visualisation time consuming, but the human operator also has to ensure that elements comprised in one element set do not overlap with each other in the floor plan, as well as with elements comprised in another element set. Otherwise the error rate, and thus the inaccuracy, of the visualisation is very high. This overlapping can lead to one element hiding or obscuring another element. This overlapping can also hide or obscure interactive component of another element. E.g., another element has an interactive component that, when clicked on with a mouse, provides a user with information about the element.

US 2012/0259743 A1 discloses a system and method that allows a human operator to select a piece of furniture. The system and method then allows the human operator to visualise the piece of furniture as part of a limited number of different furnished rooms, wherein the furnished rooms are not designed by the human operator. Therefore, the human operator is not able to choose all the furniture present in the furnished room. Furthermore, the human operator cannot move the piece of furniture in the furnished room. The camera viewing angle is also fixed, i.e., changing the viewing angle requires that the furnished room be rendered anew.

WO 2019/058266 A1 discloses a system and a method for convening a two-dimensional floor plan of a furnished room into a three-dimensional visualisation of the furnished room. However, it is not disclosed how the system and method prevents pieces of furniture from overlapping each other. It is also not disclosed that pieces of furniture can be moved around the furnished room represented by the visualisation.

Objects

An object of the present invention is to at least partially overcome at least one of the disadvantages encountered in the state of the an.

It is a further object of the invention to provide a method for producing a visualisation that can be used to represent an interior design of a room.

It is a further object of the invention to provide a method that reduces the time needed for producing said visualisation.

It is a further object of the invention to provide a method for producing said visualisation wherein all elements in said visualisation that should be visible, are visible.

It is a further object of the invention to provide a method for producing said visualisation that can be updated in real time.

It is a further object of the invention to provide a method for producing said visualisation that allows for multiple viewing angles.

It is a further object of the invention to provide a method for producing said visualisation that has a higher resolution.

It is a further object of the invention to provide a method for producing said visualisation that can be used by a human operator without training.

It is a further object of the invention to provide a method for producing said visualisation, wherein said visualisation can simultaneously display an increased number of objects.

It is a further object of the invention to provide a method for producing said visualisation that more accurately represents the interior design of a room.

It is a further object of the invention to provide a method for producing said visualisation that reduces energy consumption.

It is a further object of the invention to provide a method for producing said visualisation that reduces computer resource usage.

It is a further object of the invention to provide a method for producing said visualisation, wherein the method can be performed on different devices.

It is a further object of the invention to provide a method for producing furniture or decorative items that wastes less production material.

It is a further object of the invention to provide a method for producing furniture or decorative items with increased productivity.

It is a further object of the invention to provide a method for producing furniture or decorative items with increased production speed.

It is a further object of the invention to provide a method for producing a space, e.g., a furniture showroom, that reduces the amount of production material that is wasted.

It is a further object of the invention to provide a method for producing a space, e.g., a storage space, that optimises the usage of the space.

It is a further object of the invention to provide a method for producing a space, e.g., a furniture showroom, that has an improved safety.

### PREFERRED EMBODIMENTS OF THE INVENTION

A contribution to at least partially fulfilling at least one of the above-mentioned objects is made by any of the embodiments of the invention.

A 1^{st} embodiment of the invention is a computer implemented method for producing a visualisation, comprising the steps of
a. obtaining
   i. a first element set, wherein the first element set has a first volume,
   ii. a second element set, wherein the second element set has a second volume:
b. displaying
   i. a primary representation of a three-dimensional space,
   ii. the first element set at a first position in the primary representation,
   iii. displaying the second element set at a second position in the primary representation, wherein a distance between the first position and the second position has a first length:
c. moving the first element set from the first position to a further position in the primary representation, wherein
   i. the moving of the first element set causes the second element set to move from the second position to an even-further position in the primary representation,
   ii. the distance between the further position and the even-further position has a further length, wherein the first length and the further length vary with less than 5%, preferably by less than 3%, and more preferably by less than 1% with respect to each other.
   iii. wherein less than 5%, preferably less than 3%, and more preferably less than 1% of the first volume overlaps with the second volume.

In an aspect of the 1^{st} embodiment, it is preferred that a(i) and a(ii) are performed in any order, including at least partially simultaneously. In another aspect, it is also preferred that b(i), b(ii), and b(iii), are performed in any order, including at least partially simultaneously.

In one preferred embodiment of the present invention, as for example in the 1^{st} embodiment, the First element set is displayed at the further position in the primary representation. In another preferred embodiment of the present invention, as for example in the 1^{st} embodiment, the second element set is displayed at the even-further position in the primary representation. In these aspects it is particularly preferred that both the first element set is displayed at the further position in the primary representation and the second element set is displayed at the even-further position in the primary representation. In another preferred embodiment of the present invention, as for example in the 1^{st} embodiment, the visualisation is at least partially produced in real-time. In the context of the present invention. “real-time” is defined as the rendering of images at a rate of at least 20 frames per second. E.g., steps b. (displaying) and c. (moving) both occur in real-time. E.g., step b. displays a pre-rendered image, while step c. occurs in real-time.

In a preferred embodiment of the computer implemented method, the even-further position is determined by calculating at least one or all of the following: at least one force, at least one energy, at least one mass, at least one distance, at least one orientation, and at least one hierarchy. This preferred embodiment is a 2^{nd} embodiment of the invention, that preferably depends on the 1^{st} embodiment of the invention.

In a preferred embodiment of the computer implemented method, the even-further position is determined by calculating at least one or all of the following:
a. a repulsive force:
b. a first attractive force.

This preferred embodiment is a 3^{rd} embodiment of the invention, that preferably depends on any of the 1^{st} to 2^{nd} embodiments of the invention. For the 3^{rd} embodiment, all possible combination of the features a. and b. are preferred aspects of the embodiment. These combinations are e.g., a; b; a, b.

In a preferred embodiment of the computer implemented method, at least one or all of the following is determined by calculating a further attractive force: the first position, the second position, the further position, and the even-further position. This preferred embodiment is a 4^{th} embodiment of the invention, that preferably depends on any of the 1^{st} to 3^{rd} embodiments of the invention.

In a preferred embodiment of the computer implemented method.
a. the method further comprising the steps of calculating at least one edge between the first element set and the second element set;
b. the first element set comprises at least one first node, and the second element set comprises at least one second node.

This preferred embodiment is a 5^{th} embodiment of the invention, that preferably depends on any of the 1^{st} to 4^{th} embodiments of the invention.

In a preferred embodiment of the computer implemented method, at least one or all of the following applies:
a. the first attractive force acts between a pair of end points of the at least one edge;
b. the repulsive force acts between the at least one first node and the at least one second node.

This preferred embodiment is a 6^{th} embodiment of the invention, that preferably depends on any of the 3^{rd} to 5^{th} embodiments of the invention. For the 6^{th} embodiment, all possible combination of the features a. and b. are preferred aspects of the embodiment. These combinations are e.g., a; b; a, b.

In a preferred embodiment of the computer implemented method, the method further comprises the step of establishing a relationship between the first element set and the second element set.

This preferred embodiment is a 7^{th} embodiment of the invention, that preferably depends on any of the 1^{st} to 6^{th} embodiments of the invention.

In a preferred embodiment of the computer implemented method, the second element set starts moving in less than 10 min, preferably in less than 5 min, more preferably in less than 1 min. further preferably in less than 10 sec. even further preferably in less than 2 sec. and particularly preferred in less than 0.5 sec after the first element set starts moving. This preferred embodiment is an 8^{th} embodiment of the invention, that preferably depends on any of the 1^{st} to 7^{th} embodiments of the invention.

In a preferred embodiment of the computer implemented method, the visualisation is produced on at least one or all of the following:
a. a device of a user, e.g., a desktop computer, a laptop, a smart phone, a tablet, a virtual reality device, such as a virtual reality headset, an augmented reality device, such as an augmented reality headset or glasses:
b. a server, e.g., a web server, a cloud.

This preferred embodiment is an 9^{th} embodiment of the invention, that preferably depends on any of the 1^{st} to 8^{th} embodiments of the invention. For the 9^{th} embodiment, all possible combination of the features a, and b, are preferred aspects of the embodiment. These combinations are e.g., a; b; a, b. In the context of the present invention, the cloud does not include the device of the user. However, the device of the user can connect to the cloud via, e.g., the Internet.

In a preferred embodiment of the computer implemented method, the visualisation is produced on the server if the visualisation fails to be produced within a specified time limit on the device of the user. This preferred embodiment is a 10^{th} embodiment of the invention, that preferably depends on the 9^{th} embodiment of the invention. An example of the 10^{th} embodiment is the following: it is first attempted to produce the visualisation on a laptop of a user. If the visualisation cannot be produced within 2 sec, the visualisation will be produced on a server. The visualisation is then sent from the server to the laptop.

In a preferred embodiment of the computer implemented method, the specified time limit is 10 sec. more preferably 5 sec. further preferably 2 sec, and particularly preferred 1 sec. This preferred embodiment is an 11^{th} embodiment of the invention, that preferably depends on the 10^{th} embodiment of the invention.

In a preferred embodiment of the computer implemented method, a frame rate of the device of the user is used in order to determine whether the device of the user failed to produce the visualisation. This preferred embodiment is a 12^{th} embodiment of the invention, that preferably depends on any of the 10^{th} to 11^{th} embodiments of the invention. In the 12^{th} embodiment, it is to preferred that if the frame rate of the device of the user is below a pre-determined value, that the device is the user is deemed to have failed to produce the visualisation. In this aspect it is preferred that the pre-determined value is 40 frames per second, more preferably 50 frames per second, and further preferably 60 frames per second.

In an aspect of the invention, for example in the 9^{th} to 12^{th} embodiments, it is preferred to use websockets to communicate between the server and the device of the user.

In a preferred embodiment of the computer implemented method, the visualisation is produced on an augmented reality device, preferably an augmented reality device that comprises at least one input device. This preferred embodiment is a 13^{th} embodiment of the invention, that preferably depends on any of the 1^{st} to 12^{th} embodiments of the invention. Examples of an augmented reality device in the 13^{th} embodiment are a smart phone, a tablet, or a head-mounted display, such as glasses adapted and arranged for displaying augmented reality. Examples of at least one input device in the 13^{th} embodiment are at least one camera, at least one accelerometer, at least one GPS, at least one solid state compass, at least one motion capturing means for capturing the motion of the human operator, or a combination of two or more thereof.

In a preferred embodiment of the computer implemented method, the augmented reality device comprises at least one input device that is adapted and arranged to scan a space, preferably a three-dimensional space. This preferred embodiment is a 14^{th} embodiment of the invention, that preferably depends on the 13^{th} embodiment of the invention.

In an aspect of the invention, for example in the 14^{th} embodiment, it is preferred that the three-dimensional space is a room, e.g., a room located in a building or in a ship. Examples of the room include a room in a house of the human operator, or a room display in a furniture store. In an aspect of the invention, for example in the 14^{th} embodiment, it is preferred that at least part of the visualisation, more preferably the primary representation, is produced on the augmented reality device by scanning the space. This is in contrast to producing the visualisation on a virtual reality device, wherein the space is not scanned.

In a preferred embodiment of the computer implemented method, the visualisation is produced using at least one or all of the following:
a. a game engine, e.g., Unreal or Unity:
b. an application programming interface (API), preferably an API running in a web browser, e.g., WebGL.

This preferred embodiment is a 15^{th} embodiment of the invention, that preferably depends on any of the 1^{st} to 14^{th} embodiments of the invention. For the 15^{th} embodiment, all possible combination of the features a. and b. are preferred aspects of the embodiment. These combinations are e.g., a; b; a, b.

In a preferred embodiment of the computer implemented method, the visualisation is produced using augmented reality software, e.g., WebAR. This preferred embodiment is a 16^{th} embodiment of the invention, that preferably depends on any of the 1^{st} to 15^{th} embodiments of the invention.

In a preferred embodiment of the computer implemented method, the visualisation has a resolution of X×Y, wherein either X, Y, or both is at least 1024, preferably at least 2056, and more preferably at least 4096. This preferred embodiment is a 17^{th} embodiment of the invention, that preferably depends on any of the 1^{st} to 16^{th} embodiments of the invention.

In a preferred embodiment of the computer implemented method, the primary representation can be rotated. It is preferred that the representation can be rotated by at least 90°, more preferably by at least 180°, and further preferably by at least 360°. This preferred embodiment is an 18^{th} embodiment of the invention, that preferably depends on any of the 1^{st} to 17^{th} embodiments of the invention

In one aspect of the invention, for example the 18^{th} embodiment, it is preferred that the primary representation can be rotated around at least one axis, more preferably around at least two axes, further preferably around at least three axes. If the primary representation is a representation of a three-dimensional space, it is particularly preferred that the primary representation can be rotated in any direction.

In a preferred embodiment of the computer implemented method, the method further comprises at least one or all of the following steps:
a. changing the resolution of the visualisation, preferably the resolution of the primary representation.
b. calculating an illumination of the visualisation, preferably an illumination of the primary representation.

This preferred embodiment is a 19^{th} embodiment of the invention, that preferably depends on any of the 1^{st} to 18^{th} embodiments of the invention. Examples of changing the resolution in the 19^{th} embodiment are: increasing the resolution of the visualisation, decreasing the resolution of the visualisation, replacing a first visualisation with a further visualisation, replacing a further visualisation with a first visualisation. In the 19^{th} embodiment, examples of changing the resolution of the primary representation are: changing the resolution of a single element comprised in the primary representation, changing the resolution of all element sets comprised in the primary representation. In the 19^{th} embodiment, examples of calculating the illumination of the primary representation include: calculating the illumination for a part of the primary representation, calculating the illumination for the whole primary representation.

It is preferred that lien the method for producing the visualisation comprises the steps of the 1^{st} embodiment, and at least one step from the 19^{th} embodiment, that these steps can be performed in any order, including simultaneously. E.g., the step of changing the resolution in the 19^{th} embodiment is performed after the second element set has been moved to the even further position. E.g., the step of calculating the illumination in the 19^{th} embodiment is performed prior to displaying the primary representation. In an aspect of the invention, for example in the 19^{th} embodiment, it is preferred to change the resolution of the visualisation multiple times. In another aspect of the invention, for example in the 19^{th} embodiment, it is preferred to calculate the illumination of the visualisation multiple times.

In a preferred embodiment of the computer implemented method, the visualisation is only partially rendered. This preferred embodiment is a 20^{th} embodiment of the invention, that preferably depends on any of the 1^{st} to 19^{th} embodiments of the invention.

In a preferred embodiment of the computer implemented method, the computational resources available on the device of the user is used to determine the quality of the visualisation that is produced on the device of the user. This preferred embodiment is a 21^{st} embodiment of the invention, that preferably depends on any of the 1^{st} to 20^{th} embodiments of the invention. In a preferred embodiment of the computer implemented method, the visualisation is produced using multithreading. This preferred embodiment is a 22^{nd} embodiment of the invention, that preferably depends on any of the 1^{st} to 21^{st} embodiments of the invention.

In a preferred embodiment of the computer implemented method, the human operator views the primary representation using a first-person perspective, a third-person perspective, or both. This preferred embodiment is a 23^{rd} embodiment of the invention, that preferably depends on any of the 1^{st} to 22^{nd} embodiments of the invention.

A first-person perspective is defined as the human operator viewing the primary representation as if the human operator is part of primary representation. E.g., the primary representation represents a dining room. The human operator only sees that part of the dining room in the primary representation that the human operator would see if the human operator were physically standing in the dining room. Therefore, the human operator does not see the entire dining room. A third-person perspective is defined as the human operator viewing the primary representation from an outside perspective, e.g., when viewing a diorama.

In a preferred embodiment of the computer implemented method, the primary representation is displayed to the human operator using an orbital viewpoint, a translational viewpoint, or both.

This preferred embodiment is a 24^{th} embodiment of the invention, that preferably depends on any of the 1^{st} to 23^{rd} embodiments of the invention.

An orbital viewpoint is defined as a viewpoint which has a fixed point that the human operator faces to. If the human operator changes the viewing angle of the primary representation, then the primary representation orbits around the fixed point. E.g., the primary representation represents a living room, with a coffee table placed at the centre of the living room. Changing the viewing angle represents the human operator walking around the living room along a circular path, while facing the coffee table. A translational viewpoint is defined as a viewpoint that can be adjusted along an axis. i.e., does not involve a rotation or a change in the viewing angle.

In one aspect of the invention, for example in the 24^{th} embodiment, it is preferred that an adjustment in the translational viewpoint results in a change in a size of at least one element set positioned in the primary representation, without moving the at least one element set in the primary representation. E.g., the primary representation represents a dining room. Adjusting the translational view point represents the human operator walking through the dining room in a straight line.

In a preferred embodiment of the computer implemented method, the resolution of at least one element set in the primary representation is determined by a distance perceived by the human operator. This preferred embodiment is a 25^{th} embodiment of the invention, that preferably depends on any of the 1^{st} to 24^{th} embodiments of the invention.

In a preferred embodiment of the computer implemented method, the first element set, the second element set, or both, are obtained by creating the aforementioned element sets from 2-dimensional images, preferably images of physical items. This preferred embodiment is a 26^{th} embodiment of the invention, that preferably depends on any of the 1^{st} to 25^{th} embodiments of the invention.

In a preferred embodiment of the computer implemented method, the first element set, the second element set, or both, are obtained by querying at least one database. This preferred embodiment is a 27^{th} embodiment of the invention, that preferably depends on any of the 1^{st} to 26^{th} embodiments of the invention.

In a preferred embodiment of the computer implemented method, prior to displaying an element set, the element set is stored in a buffer. This element set can be at least one or all of the following: the first element set, the second element set, at least one further element set. This preferred embodiment is a 28^{th} embodiment of the invention, that preferably depends on any of the 1^{st} to 27^{th} embodiments of the invention.

In a preferred embodiment of the computer implemented method, the method further comprises the step of recording input from a human operator, preferably through at least one or all of the following: input via mouse, input via touch, recording gestures of the human operator, and recording audio, preferably a voice. This preferred embodiment is a 29^{th} embodiment of the invention, that preferably depends on any of the 1^{st} to 28^{th} embodiments of the invention.

In a preferred embodiment of the computer implemented method, a human operator can interact with at least one or all of the following: the first element set, the second element set, and at least one further element set. This preferred embodiment is a 30^{th} embodiment of the invention, that preferably depends on any of the 1^{st} to 29^{th} embodiments of the invention.

In a preferred embodiment of the computer implemented method, the visualisation is displayed via a display device selected from the group consisting of a screen, a video projector, a holographic projection device, an augmented reality device, a virtual reality device, or a combination of two or more thereof. This preferred embodiment is a 31^{st} embodiment of the invention, that preferably depends on any of the 1^{st} to 30^{th} embodiments of the invention.

In a preferred embodiment of the computer implemented method, the display device is connected to a computer network, preferably a local area network, and more preferably the Internet. This preferred embodiment is a 32^{nd} embodiment of the invention, that preferably depends on the 31^{st} embodiment of the invention.

In a preferred embodiment of the computer implemented method, the display device is connected to at least one database. This preferred embodiment is a 33^{rd} embodiment of the invention, that preferably depends on any of the 31^{st} to 32^{nd} embodiments of the invention.

In a preferred embodiment of the computer implemented method, the visualisation is displayed on at least two display devices, and wherein the visualisation is preferably displayed simultaneously on at least two display devices. This preferred embodiment is a 34^{th} embodiment of the invention, that preferably depends on any of the 31^{st} to 33^{rd} embodiments of the invention.

In an aspect of the invention, for example in the 34^{th} embodiment, it is preferred that when the visualisation is modified on a first display device, e.g., by moving the first element set, that the visualisation is similarly modified on at least one further display device. It is preferred that this visualisation is modified on the at least one further display device in less than 10 s, more preferably in less than 5 s, and further preferably in less than 1 s. E.g., the visualisation is displayed on both a smart phone and a laptop of the human operator. Using the visualisation displayed on the smart phone, the human operator moves an element set from a first position to a further position in the primary representation. When the human operator subsequently views the visualisation on the laptop, the visualisation has been updated to show the element set at the further position. In a further aspect of the invention, for example in the 34^{th} embodiment, it is preferred that the at least two display devices use websockets to communicate with each other.

In a preferred embodiment of the computer implemented method, the first element set, the second element set, or both, are selected from a list. This preferred embodiment is a 35^{th} embodiment of the invention, that preferably depends on any of the 1^{st} to 34^{th} embodiments of the invention.

In a preferred embodiment of the computer implemented method, the list is displayed via the display device, preferably a display device according to any of the 31^{st} to 33^{rd} embodiments. It is preferred that the list and the primary representation are both displayed in the field of view of a human. Preferably the visual field of the eyes, i.e., the spatial array of visual sensations available to observation in introspectionist psychological experiments. It is more preferred that the list and the primary representations are neighboured. This preferred embodiment is a 36^{th} embodiment of the invention, that preferably depends on 35^{th} embodiment of the invention.

In a preferred embodiment of the computer implemented method, at least one element represents at least one physical item. The at least one element can be any of the following: at least one first element comprised in the first element set, at least one second element comprised in the second element set. This preferred embodiment is a 37^{th} embodiment of the invention, that preferably depends on any of the 1^{st} to 36^{th} embodiments of the invention.

In one preferred embodiment of the present invention, for example in the 37^{th} embodiment, if a plurality of elements represent a plurality of physical items, the plurality of elements can be comprised in any number of element sets. i.e., the plurality of elements do not have to be comprised in the same element set.

In a preferred embodiment of the computer implemented method, the method further comprises the steps of acquiring at least one or all of the following: at least one first element comprised in the first element set, at least one second element comprised in the second element set. It is preferred that the acquiring is performed using at least one or all of the following: buying with money, trading, bartering, gambling, and winning a competition such as a lucky draw or raffle. This preferred embodiment is a 38^{th} embodiment of the invention, that preferably depends on any of the 1^{st} to 37^{th} embodiments of the invention.

In a preferred embodiment of the computer implemented method, the primary representation represents a room, preferably a room located in a building, or in a ship. It is preferred that the building is fit for at least one or all of the following: human habitation, working, and entertainment. This preferred embodiment is a 39^{th} embodiment of the invention, that preferably depends on any of the 1^{st} to 38^{th} embodiments of the invention.

In a preferred embodiment of the computer implemented method, at least one or all of the following represent furniture, decorative elements, or both: at least one first element comprised in the first element set, at least one second element comprised in the second element set. This preferred embodiment is a 40^{th} embodiment of the invention, that preferably depends on any of the 1^{st} to 39^{th} embodiments of the invention.

In a preferred embodiment of the computer implemented method, the primary representation is at least partially confined by a boundary, wherein the boundary has a surface area. This preferred embodiment is a 41^{st} embodiment of the invention, that preferably depends on any of the 1^{st} to 40^{th} embodiments of the invention.

In a preferred embodiment of the computer implemented method, least 95%, more preferably at least 97%, and further preferably at least 99% of the first volume, the second volume, or both, are located on the same side of the boundary. This preferred embodiment is a 42^{nd} embodiment of the invention, that preferably depends on the 41^{st} embodiment of the invention.

In a preferred embodiment of the computer implemented method, a size of at least one element comprised in any of the following: the first element set, the further element set, or at least one further element set, is not determined by the surface area of the boundary. This preferred embodiment is a 43^{rd} embodiment of the invention, that preferably depends on any of the 41^{st} to 42^{nd} embodiments of the invention.

An example of an element according to the 43^{rd} embodiment is an element that represents chair. The confining boundary represent the wall of the room. The size of a chair is not determined by the surface area of the wall. Here the size of the chair refers to at least one or all of the following: a width, a height, a length. An example that falls outside the preferred embodiment is, e.g., wallpaper. Wallpaper is generally chosen to cover the entire wall, and is therefore determined by the surface area of the wall.

In a preferred embodiment of the computer implemented method, a size of at least one element comprised in any of the following: the first element set, the second element set, or at least one further element set, is not determined by the surface area of the boundary. This preferred embodiment is a 44^{th} embodiment of the invention, that preferably depends on any of the 41^{st} to 43^{rd} embodiments of the invention.

An example of an element according to the 44^{th} embodiment is an element that represents chair. The confining boundary represent the wall of the room. The size of a chair is not determined by the surface area of the wall. Here the size of the chair refers to at least one or all of the following: a width, a height, a length. An example that falls outside the preferred embodiment is, e.g., wallpaper. Wallpaper is generally chosen to cover the entire wall, and is therefore determined by the surface area of the wall.

In a preferred embodiment of the computer implemented method, the method further comprises the step of collecting data about at least one or all of the following: the first element set, the second element set, at least one further element set, and a combination of at least two or more thereof. This preferred embodiment is a 45^{th} embodiment of the invention, that preferably depends on any of the 1^{st} to 44^{th} embodiments of the invention.

In an aspect of the 45^{th} embodiment, it is preferred to collect the data using at least one or all of the following: user input from at least one user, preferably user input from at least one user interacting with the visualisation, web crawling, reading data from a database. In an aspect of the 45^{th} embodiment, it is preferred to collect data regarding a combination of at least two elements, a combination of at least two element sets, or both. In this aspect it is more preferred to collect data regarding a combination of at least two elements, a combination of at least two element sets, or both, that a user selects for display in the primary representation. E.g., the first element set represents A, where A is a dining room table made from a specific wood, while the second element set represents B, where B are chairs with a specific colour. If a user chooses A and B to be displayed together in the primary representation, data about this specific combination (A, B) is collected. In an aspect of the 45^{th} embodiment, it is preferred to collect data regarding the physical item represented by an element, an element set, or both. E.g., the first element set represents a table, and data is collected regarding the number of times a user selects the table for display in the primary representation. E.g., the first element set represents a table, and data is collected regarding the first position where the user places the table in the primary representation. E.g., the first element set represents a table, and data is collected if the user moves the first element set from the first position to the further position in the primary representation. In an aspect of the 45^{th} embodiment, it is preferred to collect data prior to the obtaining step (step a.) in the 1^{st} embodiment. In an aspect of the 45^{th} embodiment, it is preferred to collect data after the obtaining step (step a.) in the 1^{st} embodiment, but prior to the displaying step (step b.) in the 1^{st} embodiment. In an aspect of the 45^{th} embodiment, it is preferred to collect data after the displaying step (step b.) in the 1^{st} embodiment.

In a preferred embodiment of the computer implemented method, the method further comprises the step of analysing the collected data to obtain analysed data. This preferred embodiment is a 46^{th} embodiment of the invention, that preferably depends on the 45^{th} embodiment of the invention.

In a preferred embodiment of the computer implemented method, either the collected data, or the analysed data, or both determines the obtaining, preferably the obtaining according to step a.) in the 1^{st} embodiment, of at least one or all of the following:
a. the first element set:
b. the second element set:
c. at least one further element set.

This preferred embodiment is a 47^{th} embodiment of the invention, that preferably depends on any of the 45^{th} to 46^{th} embodiments of the invention. For the 47^{th} embodiment, all possible combination of the features a, to c. are preferred aspects of the embodiment. These combinations are e.g., a; b; c; a, b; a, c; b, c; a, b, c. An example of the 47^{th} embodiment is the following: a user wants to furnish a dining room. i.e., the primary representation should represent a dining room. The analysed data is used to determine which physical items the first element set and the second element set should represent. These physical items are then presented to the user as suggestions of items that may be displayed in the primary representation.

In a preferred embodiment of the computer implemented method, either the collected data, or the analysed data, or both determines the displaying, preferably the displaying according to step b.) in the 1^{st} embodiment, of at least one or all of the following:
a. the primary representation:
b. the first element set at the first position in the primary representation,
c. the second element set at the second position in the primary representation:
d. at least one further element set at another position in the primary representation.

This preferred embodiment is a 48^{th} embodiment of the invention, that preferably depends on any of the 45^{th} to 47^{th} embodiments of the invention. For the 48^{th} embodiment, all possible combination of the features a, to d. are preferred aspects of the embodiment. These combinations are e.g., a; b; c; d; a, b; a, c; a, d; b, c; b, d; c, d; a, b, c; a, b, d; a, c, d; b, c, d; a, b, e, d. An example of the 48^{th} embodiment is the following: a user wants to furnish a dining room. i.e., the primary representation should represent a dining room. The analysed data is used to determine which physical items the first element set and the second element set should represent, as well as where these items should be positioned in the primary representation. An example of the 48^{th} embodiment is the production of a pre-determined primary representation.

In a preferred embodiment of the computer implemented method, further data of the obtaining, preferably the obtaining according to step a.) in the 1^{st} embodiment, of at least one or all of the following is collected:
a. the first element set:
b. the second element set:
c. at least one further element set.

This preferred embodiment is a 49^{th} embodiment of the invention, that preferably depends on any of the 45^{th} to 48^{th} embodiments of the invention. For the 49^{th} embodiment, all possible combination of the features a, to c. are preferred aspects of the embodiment. These combinations are e.g., a; b; c; a, b; a, c; b, c; a, b, c. An example of further data in the 49^{th} embodiment is the following: a user wants to furnish a dining room, i.e., the primary representation should represent a dining room. The analysed data is used to determine which physical items the first element set and the second element set should represent. These physical items are then presented to the user as suggestions of items that may be displayed in the primary representation. Instead of selecting all of the suggested items for display, the user only selects some of the suggested items for display. Additionally, or alternatively, the user may select at least one item for display that was not suggested to the user. Data regarding this removal, addition, or replacement of suggested items are examples of further data of the obtaining.

In a preferred embodiment of the computer implemented method, further data of the displaying, preferably the displaying according to step b.) in the 1^{st} embodiment, of at least one or all of the following is collected:
a. the primary representation;
b. the first element set at the first position in the primary representation.
c. the second element set at the second position in the primary representation:
d. at least one further element set at another position in the primary representation.

This preferred embodiment is a 50^{th} embodiment of the invention, that preferably depends on any of the 45^{th} to 49^{th} embodiments of the invention. For the 50^{th} embodiment, all possible combination of the features a, to d. are preferred aspects of the embodiment. These combinations are e.g., a; b; c; d; a, b; a, c; a, d; b, c; b, d; c, d; a, b, c; a, b, d; a, c, d; b, c, d; a, b, c, d. An example of the further data in the 50^{th} embodiment is the following: a user selects a first position where a first element set is to be displayed in the primary representation. Another example of further data in the 50^{th} embodiment is the following: a user selects a first position where a first element set is to be displayed in the primary representation, as well as a second position where a second element set is to be displayed in the primary representation. Data regarding e.g., a combination of the first position and the further position is an example of further data of the displaying. Data regarding e.g., a distance between the first position and the further position is an example of further data of the displaying.

In a preferred embodiment of the computer implemented method further data of the moving, preferably the moving according to step c.) in the 1^{st} embodiment, of at least one or all of the following is collected:
a. the moving of the first element set from the first position to the further position in the primary representation;
b. the moving of the second element set from the second position to the even-further position in the primary representation;
c. the moving of at least one further element set in the primary representation.

This preferred embodiment is a 51^{st} embodiment of the invention, that preferably depends on any of the 45^{th} to 50^{th} embodiments of the invention. For the 51^{st} embodiment, all possible combination of the features a, to c. are preferred aspects of the embodiment. These combinations are e.g., a; b; c; a, b; a, c; b, c; a, b, c. An example of the further data in the 51^{st} embodiment is the following: a user moves an element set from a first position to a further position in the primary representation. An example of the further data in the 51^{st} embodiment is the following: a user moves multiple element sets in the primary representation. A combination of the movement of the multiple element sets is an example of further data of the moving.

In a preferred embodiment of the computer implemented method, the collected further data is analysed to obtain analysed further data. This preferred embodiment is a 52^{nd} embodiment of the invention, that preferably depends on any of the 49^{th} to 51^{st} embodiments of the invention. In an aspect of the 52^{nd} embodiment, it is preferred to analyse the collected data with the collected further data to obtain the analysed further data. In an aspect of the 52^{nd} embodiment, it is preferred to use the analysed further data for at least one further user interacting with the visualisation. In this aspect, it is preferred to use the analysed further data for at least one or all of the following: suggesting at least one element set for display in the primary representation; displaying at least one element set at a position, where the position is determined by the analysed further data; suggesting at least one combination of element sets to be displayed in the primary representation; displaying at least one combination of elements sets at, at least one combination of positions in the primary representation, where the at least one combination of positions is determined by the analysed further data.

In a preferred embodiment of the computer implemented method, artificial intelligence, machine learning, statistical inference, or a combination of at least two or more thereof, is used to analyse at least one or all of the following:
a. the collected data:
b. the collected further data.

This preferred embodiment is a 53^{rd} embodiment of the invention, that preferably depends on any of the 45^{th} to 52^{nd} embodiments of the invention. For the 53^{rd} embodiment, all possible combination of the features a. and b. are preferred aspects of the embodiment. These combinations are e.g., a; b; a, b.

A 54^{th} embodiment of the invention is a visualization obtainable by a computer implemented method, according to the invention, for producing a visualisation, preferably the computer implemented method according to any of the 1^{st} to 53^{rd} embodiments of the invention.

A 55^{th} embodiment of the invention is a data processing device comprising means for carrying out a computer implemented method, according to the invention, for producing a visualisation, preferably the computer implemented method according to any of 1^{st} to 53^{rd} embodiments of the invention, wherein the data processing device comprises at least one or all of the following:
a. at least one processing unit;
b. at least one display device, preferably a display device according to any of the 31^{st} to 33^{rd} embodiments;
c. at least one network card;
d. at least one input device;
e. at least one graphics processing unit;
f. at least one storage medium.

For the 55^{th} embodiment, all possible combination of the features a, to f. are preferred aspects of the embodiment. These combinations are e.g., a; b; c; d; e; f; a, b; a, c; a, d; a, e; a, f; b, c; b, d; b, e; b, f; c, d; c, e; c, f; d, e; d, f; e, f; a, b, c; a, b, d; a, b, e; a, b, f; a, c, d; a, c, e; a, c, f; a, d, e; a, d, f; a, e, f; b, c, d; b, c, e; b, c, f; b, d, e; b, d, f; b, e, f; c, d, e; c, d, f; c, e, f; d, e, f; a, b, c, d; a, b, c, e; a, b, c, f; a, b, d, e; a, b, d, f; a, b, e, f; a, c, d, e; a, c, d, fa, c, e, f; a, d, e, f; b, c, d, e; b, c, d, f; b, c, e, f; b, d, e, f; c, d, e, f; a, b, c, d, e; a, b, c, d, f; a, b, c, e, f; a, b, d, e, f; a, c, d, e, f; b, c, d, c, e, f; a, b, c, d, e, f;

In the 55^{th} embodiment, examples of an input device are amongst others: a keyboard, a mouse, a touchpad, a sensor, a camera, an audio capturing means, a motion capturing means, a communication means, or a combination of two or more thereof. An example of an audio capturing means is a microphone. Examples of communication means include a blue tooth communication means, an infra-red communication means, a wi-fi communication means, a near-field communication means, or a combination of two or more thereof. Examples of sensors include microelectromechanical systems sensors such as an accelerometer, a GPS, a gyroscope, a solid-state compass, or a combination of two or more thereof.

In a preferred embodiment of the data processing device, the data processing device is connected to a network, preferably a local area network, and more preferably the Internet. This preferred embodiment is a 56^{th} embodiment of the invention, that preferably depends on the 55^{th} embodiment of the invention

A 57^{th} embodiment of the invention is a computer program comprising instructions which, when the program is executed by a computer, causes the computer to carry out a computer implemented method, according to the invention, for producing a visualisation, preferably the computer implemented method according to of any of the 1^{st} to 53^{rd} embodiments. Examples of computer programs in the 57^{th} embodiment are: a program that runs locally on the device of the user, e.g., a program that runs in a web browser; a program that runs on a server, e.g., a website, or a combination thereof.

In a preferred embodiment of the computer program, the computer program can be integrated with, or comprises, at least one or all of the following:
a. a game engine, e.g., the Unity game engine or the Unreal game engine;
b. machine learning software, e.g., TensorFlow;
c. artificial intelligence software, e.g., IBM Watson;
d. design software, e.g., Blender, Autodesk Maya;
e. file compression software, e.g., WinZip;
f. a database, e.g., PostgreSQL or MongoDB;
g. location software, e.g., GPS software;
h. messaging software, preferably instant messaging software, e.g., Slack:
i. application programming interface:
j. workflow software, e.g., SAP:
k, a sales platform, e.g., Ebay or Amazon.

This preferred embodiment is a 58^{th} embodiment of the invention, that preferably depends on the 57^{th} embodiment of the invention. For the 58^{th} embodiment, all possible combination of the features a, to k. are preferred aspects of the embodiment. Examples of the software in the 58^{th} embodiment are commercially available and well-known to a person skilled in the art.

In a preferred embodiment of the computer program, the computer program can be integrated with, or comprises, at least one or all of the following:
a. motion software, e.g., gyroscope software and accelerometers software;
b. motion capturing software, e.g., software capturing the motions of a human operator;
c. audio capturing software;
d. speech recognition software, e.g., Alexa and Siri;
e. image recognition software;
f. application programming interface, e.g., WebGL;
g. augmented reality software, e.g., WebAR,
h. virtual reality software, e.g., WebX.
i. software for creating user accounts,
j. user authentication software,
k. software for purchasing items or products.
l. social media platform, e.g., Facebook, Twitter, Instagram.

This preferred embodiment is a 59^{th} embodiment of the invention, that preferably depends on any of the 57^{th} to 58^{th} embodiments of the invention. For the 59^{th} embodiment, all possible combinations of the features a, to l. are preferred aspects of the embodiment. Examples of the software in the 59^{th} embodiment are commercially available and well-known to a person skilled in the art. In another embodiment of the present invention, all possible combinations of the features a, to k, in the 58^{th} embodiment, together with all possible combinations of the features a, to l, in the 59^{th} embodiment, are preferred.

In a preferred embodiment of the computer program, the computer program can be integrated with, or comprises data analysis software. This preferred embodiment is a 60^{th} embodiment of the invention, that preferably depends on any of the 57^{th} to 59^{th} embodiments of the invention.

A 61^{st} embodiment of the invention is a computer-readable data carrier having stored thereon a computer program according to the invention, preferably the computer program of any of the preceding 57^{th} to 60^{th} embodiments of the invention.

A 62^{nd} embodiment of the invention is a method for producing at least one physical item, preferably a furniture or decorative item, comprising the steps of
a. providing a visual representation of the at least one physical item, wherein the visual representation is preferably the first element set or the second element set according to a computer implemented method, according to the invention, for producing a visualisation, preferably the method of any of the 1^{st} to 53^{rd} embodiments;
b. selecting the visual representation;
c. producing the at least one physical item of a material after said selecting to obtain the at least one physical item.

In a preferred embodiment of the method for producing at least one physical item, the material is a building material. This preferred embodiment is a 63^{rd} embodiment of the invention, that preferably depends on the 62^{nd} embodiment of the invention.

In a preferred embodiment of the method for producing at least one physical item, the building material is selected from the group consisting of wood, laminate, metal, plastic, cloth, leather, glass, stone, ceramic, fabric, paper, cardboard, plant material, resin, and glue, or a combination of at least two or more thereof. This preferred embodiment is a 64^{th} embodiment of the invention, that preferably depends on the 63^{rd} embodiment of the invention.

In a preferred embodiment of the method for producing at least one physical item, the at least one physical item is produced through at least one or all of the following: building, printing, casting, and growing, or a combination of two or more thereof. This preferred embodiment is a 65^{th} embodiment of the invention, that preferably depends on any of the 62^{nd} to 64^{th} embodiments of the invention.

In a preferred embodiment of the method for producing at least one physical item, at least one characteristic of the at least one physical item that is produced is determined by a computer implemented method, according to the invention, for producing a visualisation, preferably the computer implemented method of visualisation according to any of the 1^{st} to 53^{rd} embodiments. This preferred embodiment is a 66^{th} embodiment of the invention, that preferably depends on any of the 62^{nd} to 65^{th} embodiments of the invention. In the 66^{th} preferred embodiment, examples of the at least one characteristic include a height, a length, a width, a mass, and the number of physical items.

In a preferred embodiment of the method for producing at least one physical item, the selecting is conveyed to a production unit. This preferred embodiment is a 67^{th} embodiment of the invention, that preferably depends on any of the 62^{nd} to 66^{th} embodiments of the invention.

In a preferred embodiment of the method for producing at least one physical item, the selecting is conveyed using at least one or all of the following: wireless communication, and wired communication, or a combination of at least two or more thereof. This preferred embodiment is a 68^{th} embodiment of the invention, that preferably depends on the 67^{th} embodiment of the invention. In the 68^{th} preferred embodiment, examples of wireless communication include 3G, 4G, and 5G. Bluetooth, satellite communication. Examples of wired communication include telephone lines and fibre optic communication.

In a preferred embodiment of the method for producing at least one physical item, the production unit is selected from the group consisting of a printer, a cutter, a melting device, an injecting device, a mould, a fabric production device, an extruder, a plating device, a laser, and a saw, or a combination of at least two or more thereof. This preferred embodiment is a 69^{th} embodiment of the invention, that preferably depends on any of the 67^{th} to 68^{th} embodiments of the invention.

In a preferred embodiment of the method for producing at least one physical item, the at least one physical item is acquired from at least one supplier. The at least one item can be acquired by at least one or all of the following: buying with money, trading, bartering, gambling, and winning a competition such as a lucky draw or raffle. This preferred embodiment is a 70^{th} embodiment of the invention, that preferably depends on any of the 62^{nd} to 69^{th} embodiments of the invention.

In a preferred embodiment of the method for producing at least one physical item, at least one or all of the following determines at least one characteristic of the at least one physical item:
a. collected data, preferably the collected data according to any of the 45^{th} to 53^{rd} embodiments;
b. analysed data, preferably the analysed data according to any of the 46^{th} to 53^{rd} embodiments;
c. collected further data, preferably the collected further data according to any of the 49^{th} to 53^{th} embodiments;
d. analysed further data, preferably the analysed further data according to any of the 52^{nd} to 53^{nd} embodiments.

This preferred embodiment is a 71^{st} embodiment of the invention, that preferably depends on any of the 62^{nd} to 70^{th} embodiments of the invention. For the 71^{st} embodiment, all possible combination of the features a, to d. are preferred aspects of the embodiment. These combinations are e.g., a; b; c; d; a, b; a, c; a, d; b, c; b, d; c, d; a, b, c; a, b, d; a, c, d; b, c, d; a, b, c, d. In an aspect of the 71^{st} embodiment, examples of the characteristics are a size, a colour, a material that the at least one physical item is made of, the number of physical items that are produced.

A 72^{nd} embodiment of the invention is a method for transporting at least one physical item comprising the steps of
a. taking the at least one physical item produced according to a method, according to the invention, for producing at least one physical item, preferably the method of any of the 62^{nd} to 71^{st} embodiments:
b. physically moving the at least one physical item at least for 1 km, preferably at least 5 km, and more preferably at least 50 km.

In a preferred embodiment of the method for transporting at least one physical item, the physical moving is selected from the group consisting of shipping, flying, delivering by road vehicle, preferably a truck, and delivering by rail transport, preferably a train, or a combination of at least two or more thereof. This preferred embodiment is a 73^{rd} embodiment of the invention, that preferably depends on the 72^{nd} embodiment of the invention.

A 74^{th} embodiment of the invention is a first method for producing a space, preferably a room, comprising at least one physical item, wherein the position of the at least one physical item in the space is determined using a computer implemented method, according to the invention, for producing a visualisation, preferably the computer implemented method for producing a visualisation according to of any of the 1^{st} to 53^{rd} embodiments.

In a preferred embodiment of the first method for producing a space, the at least one physical item is obtained according to a method, according to the invention, for producing at least one physical item, preferably the method of any of the 62^{nd} to 71^{st} embodiments. This preferred embodiment is a 75^{th} embodiment of the invention, that preferably depends on the 74^{th} embodiment of the invention.

In a preferred embodiment of the first method for producing a space, the at least one physical item is transported according to a method, according to the invention, for transporting at least one physical item, preferably the method of any of the 72^{nd} to 73^{rd} embodiments. This preferred embodiment is a 76^{th} embodiment of the invention, that preferably depends on any of the 74^{th} to 75^{th} embodiments of the invention.

In a preferred embodiment of the first method for producing a space, the space is a physical showroom, preferably a physical furniture showroom. This preferred embodiment is a 77^{th} embodiment of the invention, that preferably depends on any of the 74^{th} to 76^{th} embodiments of the invention.

A 78^{th} embodiment of the invention is a second method for producing a space, preferably a three-dimensional space, more preferably a physical showroom, and further preferably a furniture showroom, comprising at least one physical item, preferably a furniture item, wherein the method comprises the steps of
a. obtaining
   i. a first element set,
   ii. a second element set;
b. displaying
   i. a primary representation of the space,
   ii. the first element set in the primary representation, and
   iii. the second element set in the primary representation;
c. collecting further data about at least one or all of the following:
   i. the first element set,
   ii. the second element set;
d. analysing the collected further data to obtain analysed further data;
e. producing the space:
wherein
   either a position, at least one characteristic, or both, of the at least one physical
   item in the space is determined by the analysed further data.

In an aspect of the 78^{th} embodiment, it is preferred to use the visualisation according to the 54^{th} embodiment for the obtaining step (step a, in the 78^{th} embodiment). In an aspect of the 78^{th} embodiment, it is preferred to use the visualisation according to the 54^{th} embodiment for the displaying step (step b, in the 78^{th} embodiment). In an aspect of the 78^{th} embodiment, it is preferred to use the visualisation according to the 54^{th} embodiment for the collecting step (step c, in the 78^{th} embodiment).

An example of further data in the 78^{th} embodiment is the following: a user wants to produce a space comprising dining room furniture. i.e., the primary representation should represent a dining room section of a furniture showroom. Physical items are presented to the user as suggestions of items that may be displayed in the primary representation. Instead of selecting all of the suggested items for display, the user only selects some of the suggested items for display. Additionally, or alternatively, the user may select at least one item for display that was not suggested to the user. Data regarding this removal, addition, or replacement of suggested items are examples of further data.

An example of the further data in the 78^{th} embodiment is the following: a user selects a first position where a first element set is to be displayed in the primary representation. Another example of further data in the 78^{th} embodiment is the following: a user selects a first position where a first element set is to be displayed in the primary representation, as well as a second position where a second element set is to be displayed in the primary representation. Data regarding e.g., a combination of the first position and the further position is an example of further data. Data regarding e.g., a distance between the first position and the further position is an example of further data.

An example of the further data in the 78^{th} embodiment is the following: a user moves an element set from a first position to a further position in the primary representation. An example of the further data in the 78^{th} embodiment is the following: a user moves multiple element sets in the primary representation. A combination of the movement of the multiple element sets is an example of further data.

In an aspect of the 78^{th} embodiment, it is preferred to analyse the collected further data with collected data to obtain the analysed further data. In an aspect of the 78^{th} embodiment, it is preferred to use the analysed further data for at least one or all of the following: suggesting at least one element set for display in the primary representation; displaying at least one element set at a position, where the position is determined by the analysed further data; suggesting at least one combination of element sets to be displayed in the primary representation; displaying at least one combination of elements sets at, at least one combination of positions in the primary representation, where the at least one combination of positions is determined by the analysed further data.

In a preferred embodiment of the second method for producing a space, the method further comprises the step of collecting data about at least one or all of the following: the first element set, the second element set, at least one further element set, and a combination of at least two or more thereof. This preferred embodiment is a 79^{th} embodiment of the invention, that preferably depends on the 78^{th} embodiment of the invention.

In an aspect of the 79^{th} embodiment, it is preferred to collect the data using at least one or all of the following: user input from at least one user, preferably user input from at least one user interacting with visualisation according to the 54^{th} embodiment, web crawling, reading data from a database. In an aspect of the 79^{th} embodiment, it is preferred to collect data regarding a combination of at least two elements, a combination of at least two element sets, or both. In this aspect it is more preferred to collect data regarding a combination of at least two elements, a combination of at least two element sets, or both, that a user selects for display in the primary representation. E.g., the first element set represents A, where A is a dining room table made from a specific wood, while the second element set represents B, where B are chairs with a specific colour. If a user chooses A and B to be displayed together in the primary representation, data about this specific combination (A, B) is collected. In an aspect of the 79^{th} embodiment, it is preferred to collect data regarding the physical item represented by an element, an element set, or both. E.g., the first element set represents a table, and data is collected regarding the number of times a user selects the table for display in the primary representation. E.g., the first element set represents a table, and data is collected regarding the first position where the user places the table in the primary representation. E.g., the first element set represents a table, and data is collected if the user moves the first element set from the first position to the further position in the primary representation. In an aspect of the 79^{th} embodiment, it is preferred to collect data prior to the obtaining step (step a, in the 78^{th} embodiment). In an aspect of the 79^{th} embodiment, it is preferred to collect data after the obtaining step (step a, in the 78^{th} embodiment), but prior to the displaying step (step b, in the 78^{th} embodiment). In an aspect of the 79^{th} embodiment, it is preferred to collect data after the displaying step (step b, in the 78^{th} embodiment).

In a preferred embodiment of the second method for producing a space, the method further comprises the step of analysing the collected data to obtain analysed data. This preferred embodiment is an 80^{th} embodiment of the invention, that preferably depends on the 79^{th} embodiment of the invention.

In a preferred embodiment of the second method for producing a space, either the collected data, or the analysed data, or both determines the obtaining, preferably the obtaining according to step a.) in the 78^{th} embodiment, of at least one or all of the following:
a. the first element set:
b. the second element set:
c. at least one further element set.

This preferred embodiment is an 81^{st} embodiment of the invention, that preferably depends on any of the 79^{th} to 80^{th} embodiments of the invention.

For the 81^{st} embodiment, all possible combination of the features a, to c, are preferred aspects of the embodiment. These combinations are e.g., a; b; c; a, b; a, c; b, c; a, b, c. An example of the 81^{st} embodiment is the following: a user wants to produce a space comprising dining room furniture, i.e., the primary representation should represent a dining room section of a furniture showroom. The analysed data is used to determine which physical items the first element set and the second element set should represent. These physical items are then presented to the user as suggestions of items that may be displayed in the primary representation.

In a preferred embodiment of the second method for producing a space, either the collected data, or the analysed data, or both determines the displaying, preferably the displaying according to step b.) in the 78^{th} embodiment, of at least one or all of the following:
a. the primary representation;
b. the first element set in the primary representation;
c. the second element set in the primary representation;
d. at least one further element set in the primary representation.

This preferred embodiment is an 82^{nd} embodiment of the invention, that preferably depends on any of the 79^{th} to 81^{st} embodiments of the invention. For the 82^{nd} embodiment, all possible combination of the features a, to d. are preferred aspects of the embodiment. These combinations are e.g., a; b; c; d; a, b; a, c; a, d; b, c; b, d; c, d; a, b, c; a, b, d; a, c, d; b, c, d; a, b, c, d. An example of the 82^{nd} embodiment is the following: a user wants to produce a space comprising dining room furniture, i.e., the primary representation should represent a dining room section of a furniture showroom. The analysed data is used to determine which physical items the first element set and the second element set should represent, as well as where these items should be positioned in the primary representation. An example of the 82^{nd} embodiment is the production of a pre-determined primary representation.

In a preferred embodiment of the second method for producing a space, either machine learning, or artificial intelligence, or both, is used to analyse at least one or all of the following:
a. the collected data:
b. the collected further data.

This preferred embodiment is an 83^{rd} embodiment of the invention, that preferably depends on any of the 78^{th} to 82^{nd} embodiments of the invention.

### DETAILED DESCRIPTION OF THE INVENTION

A first aspect of the invention pertains to a visualisation comprising a primary representation, a first element set positioned in the primary representation, and a second element set positioned in the primary representation. In this aspect it is also preferred that the visualisation comprises at least one further element set positioned in the primary representation.

In the context of the present invention, the terms “user” and “human operator” are to be understood as synonyms of each other.

The Visualisation

In the context of the present invention, the visualisation is used to display an item, preferably a furniture item, to at least one viewer. The viewer is an individuum such as a mammal, preferably a human. It is preferred that the viewer is at least one potential customer, preferably this customer is interested in acquiring at least one furniture item.

In an aspect of the invention, different to the aspect set forth in e.g., the 19^{th} and 25^{th} embodiments, it is particularly preferred that the visualisation is not used to produce a further visualisation. The visualisation can also be produced from an intermediate visualisation. The intermediate visualisation can be e.g., an intermediate visualisation that has a lower resolution compared to the resolution of the visualisation. The intermediate visualisation can also be e.g., a two-dimensional image, e.g., a floor plan. In the present invention, in an aspect of the invention, different to the aspect set forth in e.g., the 19^{th} and 25^{th} embodiments, it is preferred that the visualisation is produced without using an intermediate visualisation. In an aspect of the invention, different to the aspect set forth in e.g., the 19^{th} and 25^{th} embodiments, it is preferred that when the visualisation is produced, a screen resolution is varied by less than 20%, more preferably less than 15%, and more preferably by less than 10%.

It is further preferred that the visualisation is viewed by an individuum such as a mammal, preferably a human, for at least 1 minute, more preferably at least 5 minutes, and further preferably at least 10 minutes. It is also preferred that while the visualisation is displayed, that at least one element set, more preferably at least two element sets, are moved. An example of the at least two element sets is the first element set and the second element set.

In an aspect of the invention, it is preferred that the element set, e.g., the first element set, the second element set, or at least one further element set, comprises at least one element. In this aspect it is more preferred that the at least one element comprises data that is to be displayed to the user. In this aspect it is preferred that the data is displayed as an image, more preferably an image of a geometric shape. It is further preferred that the at least one element is a representation of a three-dimensional item. It is also preferred that the at least one element is a representation of a physical item, e.g., a furniture item. In this aspect it is also preferred that the at least one element is a representation of a physical item not yet produced.

In a further aspect of the invention, it is preferred that at least two, more preferably all, of the elements comprised in an element set are similar. Examples of elements that are similar are the following: e.g., the elements represent physical objects with the same functionality, such as tables: e.g., the elements represent physical objects such as the dining room chairs of a dining room set. In this aspect it is also preferred that at least two, more preferably all, of the elements comprised in an element set are proximate. E.g., the elements represent scatter cushions that are placed on the same sofa. These scatter cushions are proximate to each other. However, these scatter cushions are not proximate to a dining room table.

In at least one preferred embodiment of the invention, the at least one element represents furniture, a decorative item, or both. These items include, amongst others, chairs, lamps, cushions, paintings, plants, electrical cables, telephones, beds, windows.

In at least one preferred embodiment of the invention, an element set has a volume. In an aspect of this embodiment, it is preferred that each element in the element set has an element-volume. In this aspect it is even more preferred that the volume is the sum of the element volumes. In this aspect it is particularly preferred that the volume, at least one sub-volume, or both, represent a physical volume, e.g., the volume of a furniture item. In a further aspect of the invention, it is preferred that less than 5%, more preferably less than 3%, and further preferably less than 1%, of the element-volume overlaps with another element volume. Here the element-volume and the another element-volume refer to element-volumes of elements comprised in the same element set, or different element sets.

In one aspect of the invention, it is particularly preferred that the volume, at least one element-volume, or both, represent a physical volume, e.g., the volume of a physical item such as a furniture item.

In another aspect of the invention, it is equally preferred that the volume, at least one element-volume, or both, does not represent a physical volume. In this aspect it is further preferred that the volume, the at least one element-volume, or both, is regular. A “regular” volume is defined as a volume that has a standard geometrical shape. Examples of standard geometrical shapes include a cube, a cuboid, a pyramid, a cylinder, a prism, a cone, a sphere, and an ellipsoid, with the cube and cuboid particularly preferred. In this aspect it is also preferred that if the element set, at least one element, or both, represent a physical item, that the volume, the at least one element-volume, or both, is larger than the volume of the physical item. E.g., the element set represents a round table. The volume of the element set is a cuboid that completely encloses the round table.

An example of overlapping volumes is the following: if two elements, each representing a piece of furniture, overlap, then a human operator viewing the visualisation will perceive that the visualisation indicates that the two pieces of furniture should at least partially pass through each other, or that one of the pieces of furniture is at least partially located inside the other piece of furniture. For example, the two elements represent a lamp and a table. Generally, the lamp should stand on a table. If the volume-elements of the two elements overlap, this will provide a visualisation that is not physically possible. i.e., the lamp passes through the table.

Note that when the elements represent physical objects that are adapted and arranged for allowing the passing through of other objects, this does not mean that the volumes or element-volume have to overlap. E.g., a table top has a hole in in that is large enough to allow a lamp to pass through the hole. In the visualisation this can still be represented by elements that non-overlapping element-volumes.

In one preferred embodiment of the invention, at least 95%, more preferably at least 97%, and further preferably at least 99% of the volume of the element set is located on the same side of a boundary that at least partially confines the primary representation. If the volume is not on the same side of the boundary, a human operator viewing the visualisation will perceive that the element set passes through the boundary.

E.g., the primary representation represents a furnished room, while the boundary represents the walls of the furnished room. Furthermore, the element set has an element that represents a table. In the primary representation, if the table does not pass through the wall, the volume of the table is located on the same side of the boundary. If the table passes through the wall, a first part of the volume is located on a first side of the boundary, and a second part of the volume is located on a second side of the boundary.

In a further aspect of the invention, it is preferred that an element set is obtained by at least one or more of the following: a.) reading data from a permanent storage device, e.g., a hard drive; b.) reading data from a temporary storage device, e.g., random access memory (RAM); c.) receiving data via a network, e.g., the Internet; d.) receiving data via user input, e.g., via a keyboard.

In one aspect of the invention, it is preferred to obtain the element set from images. These images can be, e.g., a photo of a piece of furniture, or a photo of a furnished room. It is preferred to use these images to create at least one element in the element set. In this aspect it is preferred that the at least one element represent a three-dimensional item.

In at least one preferred embodiment of the invention, a primary representation of a three-dimensional space is displayed. In this aspect it is preferred that the three-dimensional space is a physical space. In another aspect, it is further preferred that if the primary representation is displayed on a two-dimensional surface, that the primary representation is either an orthographic projection or a perspective projection of the three-dimensional space. In another aspect it is preferred that the primary representation is at least partially confined by a boundary. In this aspect it is particularly preferred that the boundary represents the walls, ceiling, and floor of a room.

In one aspect of the invention, the element set is positioned in the primary representation. In this aspect it is preferred that the position represent the average position, or coordinates, of the elements comprised in the element set.

In another aspect of the invention, the element set is moved. This moving includes at least one of the following: moving at least one, preferably all, elements comprised in the element set to a new position in the primary representation, replacing at least one, preferably all, elements comprised in the element set in the primary representation, or removing at least one, preferably all, elements comprised in the element set from the primary representation. In this aspect it is preferred that if at least one or all elements are replaced, that the volume of the element set changes.

In the aspect of a moving of the first element set, it is preferred that the moving is controlled by a human operator. In a related aspect, it is particularly preferred that a moving of the second element set, caused by the moving of the first element set, does not require the control by a human operator. It is, however, also preferred that a human operator can control the moving the second element set. It is particularly preferred that if the second element set is moved, caused by the moving of the first element set, that at least 50%, more preferably at least 75%, and further preferably at least 90%, of the second elements in the second element set are moved.

In the aspect of the moving of the first element set, it is equally preferred that the moving is not controlled by a human operator, e.g., the moving is controlled by an algorithm. In the aspect of the moving of the first element set, it is also preferred that the moving is partially controlled by a human operator and an algorithm.

In another aspect if the invention, if the element set is displayed at one position, and then moved to another position, it is preferred to display the element set at the another position. E.g., the first element set is displayed at the first position, then moved to the further position, and then displayed at the further position.

Augmented Reality

In one preferred embodiment of the invention, the visualisation is produced, displayed, or both, on an augmented reality device. It is further preferred that the augmented reality device comprises at least one input device that is adapted and arranged to scan a space. It is particularly preferred that at least part of the visualisation, e.g., the primary representation, is produced on the augmented reality device by scanning the space. It is preferred that if the space comprises physical items, that the visualisation obtained by scanning the space comprises at least one element set representing at least one of the physical items. In this aspect it is more preferred that the visualisation comprises an element for each physical item present in the space. In this aspect, it is preferred that elements representing the physical items present in the space can be part of the same element set, or at least t wo different element sets.

It is equally preferred that the visualisation obtained by scanning the space does not comprise any elements. E.g., the human operator might be interested in redecorating their living room, wherein the redecorating entails replacing all the furniture. The human operator scans their living room that contains furniture, but wants the visualisation to not contains any element sets representing the furniture, i.e., the visualisation should represent an empty living room. It is also preferred that a floor plan of the space is obtainable by scanning the space.

It is further preferred that the primary representation comprised in the visualisation can be viewed in the first-person perspective, the third-person perspective, or both. E.g., the augmented reality device is a smart phone. The smart phone produces a live camera feed of the human operator's living room which is viewed from a first-person perspective. E.g., the human operator scans their entire living room in order to obtain a primary representation of their living room. The human operator views the primary representation using a third-person perspective.

In one aspect of the invention, it is preferred that a scanned image is produced when scanning the space, e.g., an augogram, a digital image, a live camera feed, or a combination thereof. It is preferred to use the scanned image for producing the visualisation.

It is more preferred that, in a first step, interest points, fiducial markers or optical flow is determined in the scanned image. In this aspect it is preferred to use feature detection methods like corner detection, blob detection, edge detection, thresholding, or a combination of at least two thereof. It is further preferred that the human operator can interact with the interest points, fiducial markers or optical flow, e.g., by moving an interest point. It is even further preferred that the human operator can add additional interest points. E.g., the space is a bedroom. The bedroom is scanned in order to produce the visualisation. The human operator can then add interest points to the primary representation comprised in the visualisation. The added interest points indicate the position of an existing window, or the position where a window will be placed. It is also preferred, in a further step, to restore a physical coordinate system from the data obtained in the first stage.

It is preferred to use at least one physical marker to produce the visualisation. Examples of physical markers are visual cues present in the space, e.g., reflective dots placed at pre-determined positions in a furnished room that is to be scanned, wherein the pre-determined positions are the corners of the room. It is, however, more preferred not to use markers to produce the visualisation. E.g., the locations of corners in a furnished room can be determined without requiring the placement of visual cues at pre-determined positions in the furnished room.

It is preferred that the human operator can add at least one new element set to the visualisation obtained by scanning the space, i.e., adding at least one element set that does not represent one or more physical items in the space. E.g., the human operator scans their living room in order to produce the primary representation of the living room. The human operator then adds a new element set representing a chair to the primary representation, wherein the element set does not correspond to any furniture items already present in the living room. This allows the human operator to determine, e.g., whether the desired chair will fit into their living room.

It is preferred that the human operator can replace at least one element set in the visualisation obtained by scanning the space. E.g., the human operator scans their living room in order to produce the primary representation of the living room. An element set represents a first sofa in the living room. The human operator replaces the first sofa in the visualisation with a further sofa, wherein the further sofa was selected from a list of sofas that can be purchased from a furniture store. The human operator can thus determine whether the further sofa fits into their living room, as well as to the style of the living room.

It is preferred that at least one dimension of the space is measured when scanning the space.

E.g., if the space is a dining room, then the at least one dimension can be a length of a wall of the dining room, or a height of a window sill in the dining room. It is also preferred that at least one dimension of at least one physical item comprised in the space is measured when scanning the space. E.g., if the space is a dining room comprising a dining room table, then the at least one dimension of the physical item can be a length of the dining room table. In this aspect it is preferred that the at least one dimension measured by scanning the space has a measuring error of less than 10%, more preferably less than 7%, and further preferably less than 5%. This allows the human operator e.g., to more accurately determine whether a desired piece of furniture will fit into their furnished room.

It is preferred that the human operator can make adjustments to the visualisation obtained by scanning the space. E.g., the human operator scans their dining room in order to produce the primary representation of the dining room. The human operator can then adjust the length of the walls of the dining room in the primary representation, or move the position of a window in the primary representation.

In the context of the present invention, augmented reality includes mixed reality. Mixed reality is defined as augmented reality wherein the human operator can interact with at least one element set in the visualisation. Here it is preferred that the at least one element set represents at least one physical item in space, at least one element set that the human operator has added to the visualisation, or both. E.g., the primary representation represents a bedroom comprising a chest of drawers. The human operator can interact with the chest of drawers by opening one of the drawers. E.g., the primary representation represents a bedroom that does not have a chest of drawers. The human operator adds an element set, representing a chest of drawers, to the primary representation. The human operator can interact with the added element set by opening the drawers. It is also preferred that a representation of the human operator can interact with at least one element set in the visualisation.

It is preferred that the visualisation, obtained by scanning, the space is produced using augmented reality software installed on the augmented reality device, e.g., using an app that the human operator has downloaded onto their smart phone. It is however, more preferred that the visualisation, obtained by scanning the space, is produced using a web browser, such as Firefox, Google Chrome. or Safari. In this aspect it is particularly preferred to use WebAR.

Position Determination

In at least one preferred embodiment of the invention, at least one or all of the following quantities are calculated in order to determine the position of the element set in the primary representation: at least one a force, at least one energy, at least one mass, at least one distance, at least one orientation, or at least one hierarchy. The aforementioned quantities should be understood to represent at least one parameter that is used in an algorithm for calculating the position of the element.

In the context of the present invention. “determining the position” of the element set should be understood to mean that the position is determined without requiring user input. E.g., the position of the element set is determined by evaluating an algorithm. This is in contrast to the scenario where the user chooses the position of the element set, e.g., by clicking and dragging the element set in the primary representation.

The aforementioned quantities can be calculated, by e.g., using the volume of the element set, or the sub-volumes of the elements comprised in the element set, e.g., the at least one distance can be a distance between elements comprised in an element set, or a distance between a first element set and a second element set, e.g., taking into account the boundary of the primary representation.

Examples of calculating the at least one orientation include the following: e.g., the visualisation represents a furnished room comprising a dining room table and dining room chairs. The dining room table is represented by a first element in the first element set, and the dining room chairs are represented by second elements comprised in the second element set. The dining room chairs should be orientated so that they face the dining room table. E.g., the visualisation represents a furnished room comprising a cupboard with doors, wherein the cupboard is placed against a wall. The cupboard is represented by a first element in the first element set. The cupboard should be orientated so that its doors can open. It is preferred that the orientation is user-defined. It is also preferred that the orientation is calculated using artificial intelligence, machine learning, or both.

In one aspect of the invention, it is preferred to determine the position of at least one element set based on a functionality of the element set. E.g., an element set representing a potted plant has a decorative functionality, whereas an element set representing a chair has a seating functionality. It is more preferred that the at least one element set does not obstruct the functionality of at least one other element set. E.g., if a first element set represent a television, and a further element set represents a potted plant, then the position of the potted plant should not be determined to be in front of the television. However, if the further element is a coffee table, the coffee table can be placed in front of the television as the coffee table will not obstruct the view of the television.

With the at least one hierarchy the following should be understood: the primary representation is a representation of a three-dimensional space. The three-dimensional space has a first dimension, a second dimension, and a further dimension. It is preferred that the further dimension is defined as a height. In this aspect, it is often also preferred that a first item set is always positioned higher than a second item set in the three-dimensional space. E.g., scatter cushions will be placed on a sofa, and not vice versa. This preferred height placement in the three-dimensional space should be represented in the positioning of the element set in the primary representation. Such a hierarchy can be established, e.g., by assigning a hierarchy number to the element set. Multiple elements sets can then be positioned according to ascending or descending hierarchy number.

In another aspect of the invention, it is preferred that the primary representation comprises exclusion zones wherein at least one element set should not be positioned. E.g., the primary representation represent a dining room, and the exclusion zone represent an area around a doorway wherein no furniture should be positioned. It is more preferred that when a human operator moves at least one element set into an exclusion zone, that the at least one element set will be moved to outside the exclusion zone without requiring input form the human operator.

In an aspect of the invention, it is preferred that when the position of at least one element set is determined, that at least one side of the at least one element set is not adjacent to at least one side of at least one further element set, at least a part of the boundary, or both. E.g., the first element set represents a couch. A further element set represents a coffee table. The primary representation represents a living room. When determining the position of the first element set and the further element set in the primary representation, the couch should be accessible from the front. i.e., the coffee table should not be placed against the front of the couch in the primary representation.

In one aspect of the invention, the at least one force comprises at least one or all of the following: a repulsive force, a first attractive force, and a further attractive force. In this aspect of the invention, it is preferred that the repulsive force acts between at least one, preferably all, pairs of elements positioned in the primary representation, e.g., between a first element comprised in the first element set and a second element comprised in the second element set, e.g., between two first elements comprised in the first element set. In this aspect it is also preferred that the repulsive force between a pair of elements is determined by the distance between the two elements. In this aspect it is particularly preferred that the repulsive force scales as Coulomb's law.

In this aspect it is also preferred that the first attractive force acts between at least one, preferably all, pairs of elements positioned in the primary representation, e.g., between a first element comprised in the first element set and a second element comprised in the second element set, e.g., between two first elements comprised in the first element set.

However, it is more preferred that the first attractive force acts between only one or all of the following:
[A] at least one, preferably all, pairs of elements comprised in the element set:
[B] between at least one, preferably all, pairs. The pair consists of one first elements comprised in the first element set, and one second elements comprised in the second element set. Furthermore, a relationship has been established between the first element set and the second element set.

It is particularly preferred that when a relationship has been established between a first element set and a second element set, that the first attractive force in [B] is stronger than the first attractive force [A].

E.g., a dining room comprising a dining room table and a plurality of dining room chairs. A first attractive force exists between the plurality of dining room chairs. Therefore, the dining room chairs will attract each other, as in [A]. However, there is also a first attractive force between each of the dining room chairs and the dining room table, as in [B]. As the dining room chairs should be arranged around the dining room table, and not only on, e.g., on side of the dining room table, the first attractive force [B] is stronger than the first attractive force [A]. This also means that if the dining room table is moved from the first position to the further position, that the plurality of dining room chairs will move with the dining room table.

It is preferred that the first attractive force between a pair of elements is determined by the distance between the two elements. In this aspect it is preferred that the first attractive force scales as Coulomb's law, and particularly preferred that the first attractive force scales as Hooke's law.

In another aspect of the invention, it is preferred that the position of the element set is determined by calculating a further attractive force. In this aspect it is preferred that the further attractive force acts between at least one, preferably all elements in the primary representation, and the boundary confining the primary representation. In this aspect it is preferred that the further attractive force between an element and the boundary is determined by the distance between the element and the boundary. In this aspect it is preferred that the further attractive force scales as Newton's law of gravity or Hooke's law. E.g., a desk lamp w % ill not hang in the air, but will fall to the floor. This effect of gravity is represented in the primary representation by the further attractive force.

In one aspect of the invention, it is preferred that the strength of the at least one force is determined by the likelihood that a relationship exists between at least two elements. This likelihood can be determined by, e.g., using artificial intelligence, machine learning, or both. E.g., there is a larger likelihood that dining room chairs in a dining room are associated with each other than a stool. Therefore, this should be represented in the method for producing the visualisation.

One possible algorithm for calculating the at least one force between elements is the Force Directed Graph Drawing algorithm (FDG). This algorithm works by defining nodes and edges. Nodes and edges have their normal meaning according to the mathematical field of graph theory. Further details of this algorithm can be found in, e.g., Kobourov, S. G. (2012). Spring Embedders and Force-Directed Graph Drawing Algorithms, arXiv:1201.3011. Bibcode:2012arXivL201.3011K. If an FDG is used, it is preferred that the elements in the primary representation are defined as the nodes in the FDG.

It is also preferred that the position of the element set is determined by making use of artificial intelligence, machine learning, or both. E.g., a table should not stand in front of a doorway. It is further preferred that when the position of the at least one element set is determined, that the at least one element set is not positioned in an exclusion zone.

It is preferred that when the positions of at least two element sets are determined, that the volumes of the at least two element sets overlap by less than 5%, more preferably by less than 3%, and further preferably by less than 1% with each other.

Relationship Between Element Sets

In at least one preferred embodiment of the invention, a relationship is established between the first element set and the second element set. It is also preferred that a relationship is established between at least one, preferably all, pairs of elements in the element set. This relationship can be established by, e.g., giving a parameter associated with the element set a particular value.

In an aspect of this embodiment, it is preferred that the relationship can be established at any time after the first element set and the second element set have been obtained. It is also preferred that any relationship that has been established can be removed. In another aspect of this embodiment, it is preferred that the relationship is established by a human operator. In this aspect it is also preferred that the relationship is established by other means, e.g., using artificial intelligence or machine learning.

E.g., the visualisation represents a furnished room comprising a dining room table and dining room chairs. The dining room table is represented by a first element in the first element set, and the dining room chairs are represented by second elements comprised in the second element set. As the dining room table and the dining room chairs are generally associated with each other, this should be reflected in the establishment of a relationship between the first element set and the second element set.

E.g., the visualisation represents a furnished room comprising a lamp and a cupboard. The lamp is represented by a first element comprised in a first element set, and the cupboard is represented by a second element comprised in a second element set. As the lamp and the cupboard are often not associated with each other, this should be reflected in the lack of a relationship between the first element set and the second element set. However, even in this case the human operator might want to associate the aforementioned element set with each other, and it is therefore preferred that the human operator can establish the relationship.

In one preferred embodiment of the present invention, the position of an element set is only determined when a relationship has been established for the element set.

In another aspect of the invention, it is preferred that there is a relationship between at least one element set and the boundary of the primary representation. E.g., an element set consists of a single element representing a cupboard. The cupboard should be placed against the wall, and not in the middle of the room. In another aspect of the invention, when a relationship has been established between at least two elements comprised in the same or different element sets, it is preferred that there is an optimal distance between the at least two elements. E.g., a first element represent a coffee table and a further element represent a sofa. The coffee table should be within arm's reach of the sofa. In this aspect it is preferred that the optimal distance is used when determining the position of at least one element set. It is preferred that the optimal distance is determined by at least one or all of the following: a human operator, artificial intelligence, or machine learning.

In a further aspect of the invention, it is preferred to use artificial intelligence, machine learning, or both, to determine the relationship between at least two elements sets, at least two elements, or both. Here the at least two elements can be comprised in the same element set, or different element sets. E.g., a first element in an element set represents a bed. A further element in the element set represents a night stand. As a night stand is generally placed beside a bed, a relationship is established between the bed and the night stand. A relationship would generally not be established between a chair and bed.

Further Aspects of the Visualisation

In one aspect of the invention, it is preferred that the human operator does not select a dimension of the primary representation. E.g., the primary representation represents a bedroom with a width and length not chosen by the human operator. In another aspect of the invention, it is preferred that the human operator selects at least one dimension of the primary representation. E.g., the primary representation represents a bedroom. The human operator selects the width and length of the bedroom. E.g., the primary representation represents a bedroom with a width and length not chosen by the human operator. The human operator can then change the width or length.

In one aspect of the invention, it is preferred that the element sets comprised in the primary representation are selected by the human operator, a computer algorithm, or both. In another aspect of the invention, it is preferred that the positions of the element sets comprised in the primary representation are selected by the human operator, a computer algorithm, or both. E.g., the human operator selects all the element sets that are comprised in the primary representation. E.g., the element sets that are comprised in the primary representation are selected by an algorithm that is based on the style preference of the user, e.g., art deco. E.g., the human operator selects all the element sets that are comprises in the primary representation, with the position of these element sets not determined by the human operator. E.g., the human operator selects and positions all the element sets comprised in the primary representation. This includes positioning the elements comprises in the element sets.

In another aspect of the invention, it is preferred the primary representation is a pre-determined primary representation. A pre-determined primary representation is defined as a primary representation that comprises at least one element set not selected or positioned by the human operator, i.e., the position of at least one element set is determined. E.g., the human operator is presented with a primary representation that comprises a plurality of element sets, wherein none of the element sets were added to the primary representation by the human operator. The human operator can then decide to replace at least one element set in the primary representation with at least one element set that is not present in the primary representation. For example, the primary representation represents a bedroom. The bedroom initially contains a first bed, a cupboard, a nightstand, and a chair. The human operator can replace the first bed with a further bed. E.g., the human operator can add at least one additional element set to the primary representation. For example, the primary representation represents a bedroom. The bedroom initially contains a bed, a cupboard, a nightstand, and a First chair. The human operator can add a further chair.

In one aspect of the invention, it is preferred that the human operator is presented with a plurality of pre-determined primary representations. In another aspect of the invention, it is preferred that artificial intelligence, machine learning, or both, are used to produce at least one pre-determined primary representation. In this aspect, it is preferred to use an objective measure, a subjective measure, or both, to train the artificial intelligence, the machine learning, or both. E.g., if the element set represents a piece of furniture, an objective measure is the usage of the furniture. For example, a chair is meant for sitting on, and not for placing a vase. E.g., if the element set represents a piece of furniture, a subjective measure is the style of furniture, such as art deco.

In yet another aspect of the invention, it is preferred that at least two human operators are presented with at least one different pre-determined primary representation. E.g., a First human operator is presented with a first pre-determined primary representation. A further human operator is presented with a further pre-determined primary representation. The first pre-determined primary representation comprises at least one element set that is not present in the further pre-determined primary representation.

In a further aspect if the invention, it is preferred that a total size of the element sets in the pre-determined primary representation is less than a size of the primary representation. Here the total size is the sum of the element set-sizes of all the element sets present in the primary representation. Examples of the size include a volume or a surface. In this aspect it is preferred that the total size of the element sets in the pre-determined primary representation is less than 90%, more preferably less than 85%, and further preferably less than 80% of the size of the primary representation

It is further preferred that the sum of the element set-sizes of element sets with the same functionality is less than a pre-determined size. E.g., the primary representation represents a living room comprising a sofa set, a television, speakers, and two bookshelves. The sofa set has a seating functionality, the television and speakers have an entertainment functionality, and the bookshelves have a storage functionality. The sofa set covers 40% of the floor space of the living room, the television and speakers cover 15% of the floor space of the living room, and the two bookshelves cover 10% of the floor space of the living room.

It is further preferred that the pre-determined size is selected by the human operator. It is also preferred that the pre-determined size is determined by artificial intelligence, machine learning, or both. It is also preferred that at least one element set-size is used to determine the position of at least one element, at least one element set, or both.

In another aspect of the invention, it is preferred that at least one element set comprised in the visualisation is obtained using an image, preferably an image of a piece of furniture, a furnished room, or both. In a further aspect of the invention, it is preferred that the primary representation is obtained using an image, preferably an image of a furnished room. Examples of images include photos, drawings, and schematic illustrations. E.g., the visualisation forms part of a website. The human operator uploads a photo of a furnished room to the website. The website comprises image recognition software that is adapted and arranged to recognise the different pieces of furniture in the photo. Furthermore, the image recognition software is adapted and arranged to recognise the brand, the model, or both, of the furniture. The human operator can then select one or more pieces of furniture in the photo to be displayed in the visualisation. E.g., the visualisation forms part of a website. The human operator uploads a photo of a furnished room to the website. The website comprises image recognition software that is adapted and arranged to recognise the different pieces of furniture in the photo. Furthermore, the image recognition software is adapted and arranged to recognise the brand, the model, or both, of the furniture. The primary representation is produced using the photo. i.e., all the pieces of furniture in the photo is represented in the primary representation by an element set.

In another embodiment of the invention, it is preferred that the primary representation comprises a representation of the human operator. In this aspect it is preferred to produce the representation of the human operator using data entered by the human operator. E.g., the human operator can use their device to enter their characteristics such as their height or hair colour. This data is used to produce a representation of the human operator. It is, however, more preferred that an augmented reality device is adapted and arranged to scan at least the face of the human operator in order to produce a representation of the human operator. In this aspect it is further preferred to produce a photo-realistic representation of at least the human operator's face, e.g., by taking a photo of the human operator's face.

In an aspect of the invention, it is preferred that the human operator can view their representation interacting with at least one element set in the primary representation. E.g., the primary representation represents a kitchen comprising a cupboard and chair. The human operator views the primary representation with a third-person perspective. The primary representation further comprises a representation of the human operator. The human operator can view their representation sitting on the chair or opening the cupboard.

In yet another aspect of the invention, it is preferred that the human operator can modify a visual appearance of at least apart of the boundary confining the primary representation. In this aspect it is preferred that an image is used to modify the visual appearance. Examples of images include photos, drawings, and schematic illustrations. E.g., the visualisation is part of a website. The human operator uploads a drawing of a floral pattern to the website. The primary representation comprised in the visualisation represents a bedroom. The floral pattern is applied to a part of the boundary that represents the walls of the bedroom.

In an aspect of the invention, it is preferred that a colour, a texture, or both, of at least one element set can be changed. In this aspect it is further preferred that the at least one element set is comprised in the primary representation. E.g., the primary representation represents a living room, and an element in the primary representation represents a blue leather couch. A human operator can change the colour of the couch to red, and change the leather to fabric. The human operator can make these changes in the primary representation.

Further Aspects of the Invention

In an embodiment of the invention, it is preferred that at least one element set can be viewed in an element representation. It is preferred that the element representation is comprised in the visualisation. It is equally preferred that the element representation is not comprised in the visualisation. E.g., the visualisation and the element representation can both be viewed on the same website. The visualisation and the element representation are displayed on two different web pages of the website.

It is further preferred that at least one element set viewed in the element representation can be added to the primary representation. Here “added” should be understood to mean that the at least one element set can be added to the primary representation, or that the at least one element set can replace another element set comprised in the primary representation, or both. E.g., if the at least one element set represents a chair, and the primary representation represents a furnished room, then the human operator can view the chair separately. i.e., the chair does not have to be positioned in the furnished room. The human operator can then decide to place the chair in the furnished room, without removing any furniture already present in the furnished room. Alternatively, the human operator can replace a piece of furniture in the furnished room with the chair.

It is further preferred that the at least one element set in the element representation can be rotated around at least one axis, more preferably around at least two axes, further preferably around at least three axes. It is particularly preferred that the at least one element set can be rotated in any direction. It is further preferred that the human operator can add the at least one element set viewed in the element representation to the primary representation. E.g., the at least one element set represents a chair. The primary representation represent a living room. The human operator views the chair in the element representation, and then adds the chair to the living room.

In another aspect of the invention, it is preferred that at least one element set comprised in the element representation is obtained using an image, preferably an image of a piece of furniture, a furnished room, or both. Examples of images include photos, drawings and schematic illustrations. E.g., the element representation forms part of a website. The human operator uploads a photo of a furnished room to the website. The website comprises image recognition software that is adapted and arranged to recognise the different pieces of furniture in the photo. Furthermore, the image recognition software is adapted and arranged to recognise the brand, the model, or both, of the furniture. The human operator can then select one or more pieces of furniture in the photo to be displayed in the element representation.

In another aspect of the invention, it is preferred that the visualisation is displayed via a virtual reality device, e.g., a head-mounted display. In this aspect it is preferred that the virtual reality device comprises an input device, e.g., at least one motion capturing means for capturing the motion of the human operator. It is preferred that the visualisation displayed via the virtual reality device represents a space, more preferably a three-dimensional space. It is further preferred that the three-dimensional space is a room, e.g., a room located in a building or in a ship. It is particularly preferred that the human operator can have the impression of walking through the visualisation, e.g., representing the human operator walking through a furnished room.

Producing the Visualisation

In the context of the present invention, producing a visualisation includes at least one or all of the following steps: rendering of graphics, evaluating logical expressions, performing calculations, preferably using an algorithm, more preferably an FDG algorithm. For the step of rendering of graphics, it is preferred to use at least one or all of the following: ray-tracing and rasterization. It is also preferred that the rendering is photorealistic.

In one preferred embodiment of the invention, the visualisation can be produced on the device of the user, a server, or both. If the visualisation is produced on the device of the user, it is preferred to produce the visualisation in a web browser, e.g., Chrome, Firefox, Safari, Opera, Microsoft Edge, or Internet Explorer. In this aspect it is preferred to use WebGL. WebGL is known to a person skilled in the art, and is commercially available from Khronos Group. Inc. USA.

If the visualisation is produced on a server, it is preferred to use a game engine. Suitable game engines are known to a person skilled in the art, and are commercially available. Suitable game engines include the Unreal Engine 4 available from Epic games, Inc., USA, and the Unity game engine available from Unity Technologies Inc., USA.

In an aspect of the invention, it is preferred that the device of the user, the server, or both comprises at least one database. Examples of a database is a relational database, e.g., SQL, or a document-orientated database, e.g., MongoDB.

In the context of the invention, a frame rate is defined as the frequency or rate at which consecutive images are displayed on a display device. It is preferred that the frame rate is a rendering frame rate. Rendering is defined as generating or producing a photorealistic or non-photorealistic image from a two-dimensional or three-dimensional model by means of a computer program. It is preferred that a model represents a physical body using a collection of points in space, preferably three-dimensional space. It is further preferred that the collection of points are connected by geometric shapes such as triangles, lines, curved surfaces, or combinations thereof it is further preferred that the models can be created by a human operator, an algorithm, or by scanning. Scanning is defined as the process of analysing a physical item or space to collect data on e.g., its shape, its colour, its texture. It is also preferred that the surfaces of the models is further defined with texture mapping. Texture mapping is defined as a method for defining e.g., high-frequency detail, surface texture, or colour information on a computer-generated graphic or model.

It is also preferred to produce the visualisation using multithreading, i.e., at least two segments of code are simultaneously executed in parallel. It is more preferred to use multithreading on the device of the user, the server, or both. It is further preferred to use multithreading on at least two central processing units (CPU), at least one graphics processing unit (GPU), or a combination thereof. Examples of using multithreading on the device of the user includes web workers. Examples of using multithreading on the server includes using OpenMP, MPI, and CUDA. It is also preferred that the visualisation is produced using a virtual machine, more preferably a virtual stack machine. It this aspect it is preferred to use WebAssembly.

In a preferred embodiment of the invention, a first visualisation is initially produced and displayed on the device of the user. After the first visualisation has been displayed, at least part of the first visualisation is replaced by a further visualisation that is produced on the server, with the further visualisation displayed to the human operator. In this aspect it is preferred that the further visualisation comprises at least one element set that has a higher resolution, compared to the resolution of the at least one element set in the first visualisation. It is preferred that the resolution of at least part of the further visualisation is at least 25%, more preferably at least 50%, and further preferably at least 100% higher than the resolution of at least part of the first visualisation.

In a related aspect, it is preferred that the first visualisation is produced, displayed, or both, when the human operator interacts with the visualisation, e.g., when moving an element set in the primary representation, or when rotating the primary representation. It is more preferred that the further visualisation is produced, displayed, or both, when the human operator is not interacting with the visualisation. E.g., the first visualisation is produced and displayed on a smart phone of a human operator. After 5 s, the first visualisation is replaced by a further visualisation on the smart phone. The further visualisation was produced on a server, and has a resolution that is 50% higher than the resolution of the first visualisation. When the human operator moves an element set in the primary representation, the first visualisation is again displayed whilst the human operator moves the element set. 5 s after the element set has stopped moving in the primary representation, the first visualisation is again replaced by the further visualisation.

In yet another embodiment of the invention, it is preferred that at least one element set in the primary representation has a resolution determined by a distance perceived by the human operator. This should be understood as follows: if the primary representation represents a furnished room, then a human operator viewing the visualisation will perceive a first item of furniture, represented by a first element set, as being further away from the viewpoint of the human operator, compared to a another item of furniture, represented by another element set. In this aspect it is preferred that element sets that are perceived as being further away have a lower resolution compared to element sets that are perceived as being closer. It is preferred that the difference in resolution between closer element sets and further away element sets is at least 25%, more preferably, 50%, and further preferably at least 100%.

It is particularly preferred that when the view % point of the primary representation is changed, thereby resulting in the perceived distance of at least one element set being changed, that the resolution of the at least one element set is also changed. E.g., the primary representation represents a living room comprising a coffee table and a sofa. Initially the living room is viewed as if the human operator is standing in a doorway of the living room, with the coffee table located closer to the doorway than the sofa. A first element set, representing the coffee table, is displayed using a higher resolution compared to the resolution of a further element set, representing the sofa. As the viewpoint is changed, representing the human operator walking towards the sofa, both the resolution of the first element set and the further element set is increased.

In another aspect of the invention, it is preferred that the visualisation is produced with a resolution that is lower than the resolution of the device of the user. In this aspect it is preferred to upscale the lower-resolution visualisation on the device of the user.

In a further aspect of the invention, it is preferred that at least two element sets in the primary representation are illuminated differently. E.g., the primary representation represents a living room comprising a couch and a chair. The chair is located in the corner of the room, whereas the couch in located in front of a living room window. A first element set, representing the couch, will have a higher level of illumination compared to the second element set, representing to the chair, due to sunlight entering the living room window. In this aspect it is preferred to calculate the illumination prior to displaying the visualisation. It is further preferred to re-calculate the illumination for at least a part of the primary representation when the at least one element set is moved in the primary representation.

It is also preferred to iteratively calculate the illumination. E.g., the primary representation represents a dining room with different levels of illumination. When the visualisation is displayed to the human operator for the first time, there is a sharp transition between light and shadow areas in the living room. The illumination is re-calculated over multiple frames, leading to a more gradual transition between light and shadow areas in the living room.

In another aspect of the invention, it is preferred to only partially render the visualisation, e.g., not rendering at least one element set that is comprised in the primary representation. E.g., the primary representation represent a bedroom comprising a bed and a chair. The human operator views the primary representation using the first-person perspective. Furthermore, the human operator looks away from the bed. Consequently, the element set representing the bed is not rendered.

In an aspect of the invention, it is preferred to use the computational resources (e.g., RAM, processing speed) available on the device of the user to determine the quality of the visualisation that is produced on the device of the user. Here the quality can refer to e.g., the resolution of the visualisation, the number of element sets in the primary representation, or a combination thereof. E.g., mobile phones have lower processing speeds than gaming computers. Therefore, the visualisation produced in a gaming computer will have a higher resolution compared to the visualisation produced on a mobile phone.

Data Processing and Computer Program

At least one preferred embodiment of the present invention is a data processing device comprising means for carrying out at least one, preferably all, preferred embodiments of the method for producing the visualisation. In this aspect it is preferred that the processing device comprises a processing unit, e.g., at least one central processing unit (CPU) that is commercially available and w % ell known to a person skilled in the art. In this aspect it is also preferred that the processing device comprises a graphics processing unit (GPU). Suitable GPUs are commercially available and well known to a person skilled in the art. It is further preferred that the data processing device comprises random access memory (RAM).

It is also preferred that the processing device comprises at least one or all of the following: an operating system, at least one device driver, at least one input device, e.g., a mouse or a keyboard. It is also preferred that the processing device comprises a storage medium that is adapted and arranged for storing a computer program. Examples of suitable storage media include a hard disk or a USB flash drive. It is particularly preferred that the data processing device is a personal computer or a laptop. It is also preferred that the data processing device is a smart phone or tablet. It is even further preferred that the data processing device is adapted and arranged for augmented reality, virtual reality, or both.

In the context of the present invention, any number of embodiments, aspects, or both, can be combined with each other in order to obtain further embodiments, aspects, or both. The invention is now illustrated by non-limiting examples, figures, and exemplifying embodiments.

Data

In an aspect of the invention. “collected data” is preferably data that has been collected from at least one previous user that has interacted with the visualisation. Here the at least one previous user is a user that has interacted with the visualisation prior to an interaction of at least one current user with the visualisation. In another aspect of the invention, “collected further data” is preferably data that is being collected from at least one current user that is interacting with the visualisation.

### FIGURES

Note that the figures are not drawn to scale.

### LIST OF FIGURES

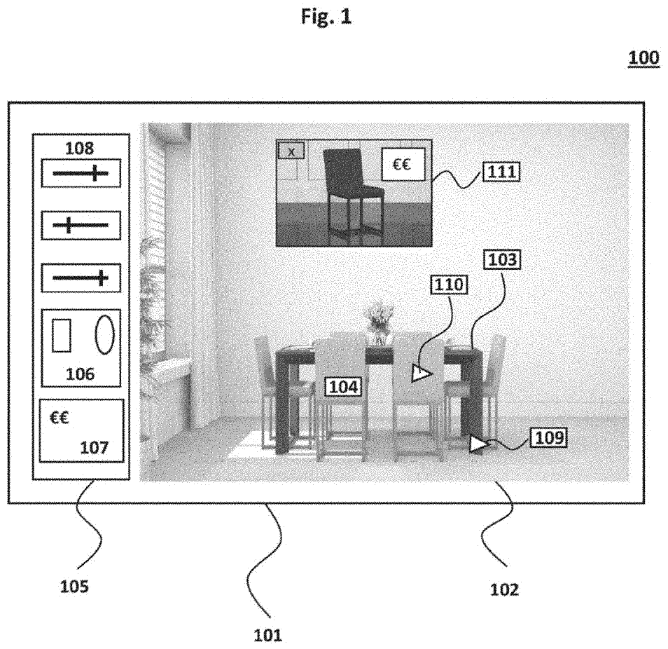

FIG. 1: an illustration of a visualisation.

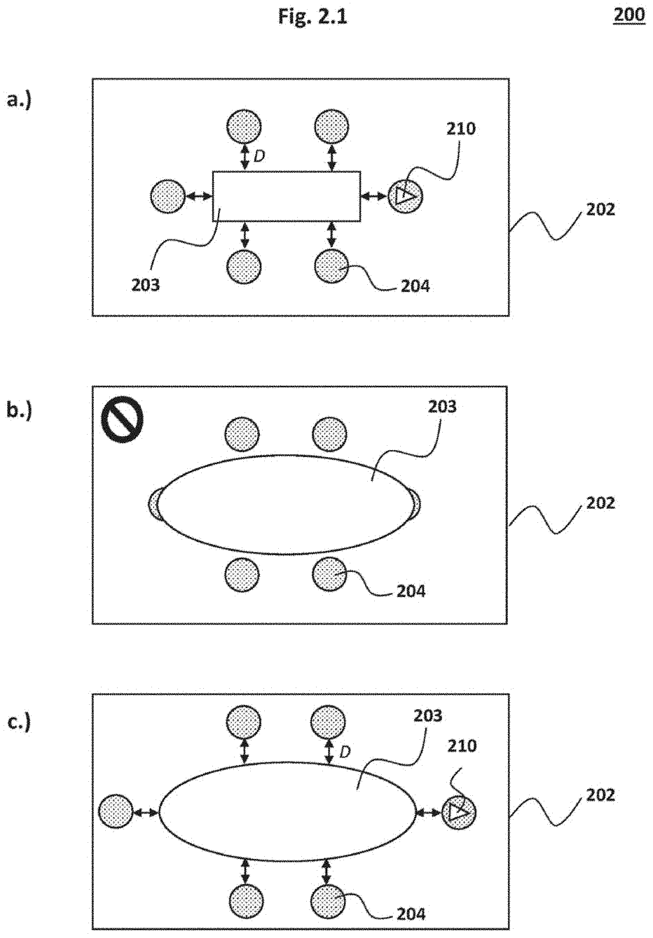

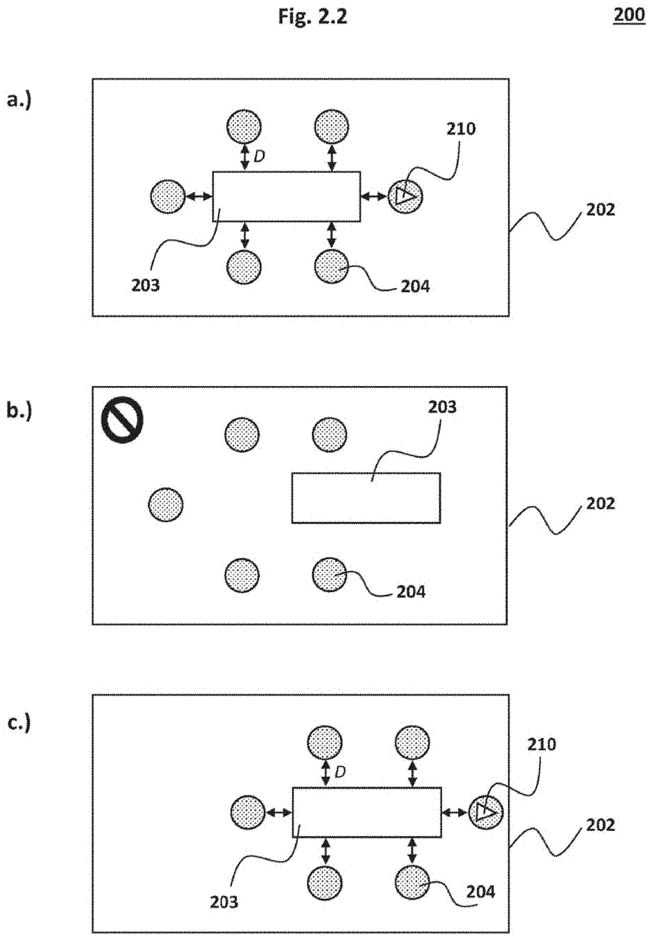

FIG. 2a: a first example of the method for producing a visualisation.

FIG. 2b: a second example of the method for producing a visualisation.

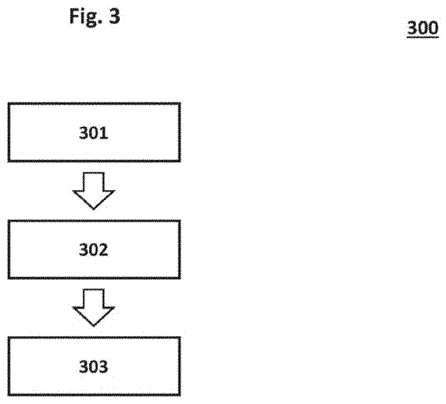

FIG. 3: diagram showing the steps comprised in the method for producing a visualisation.

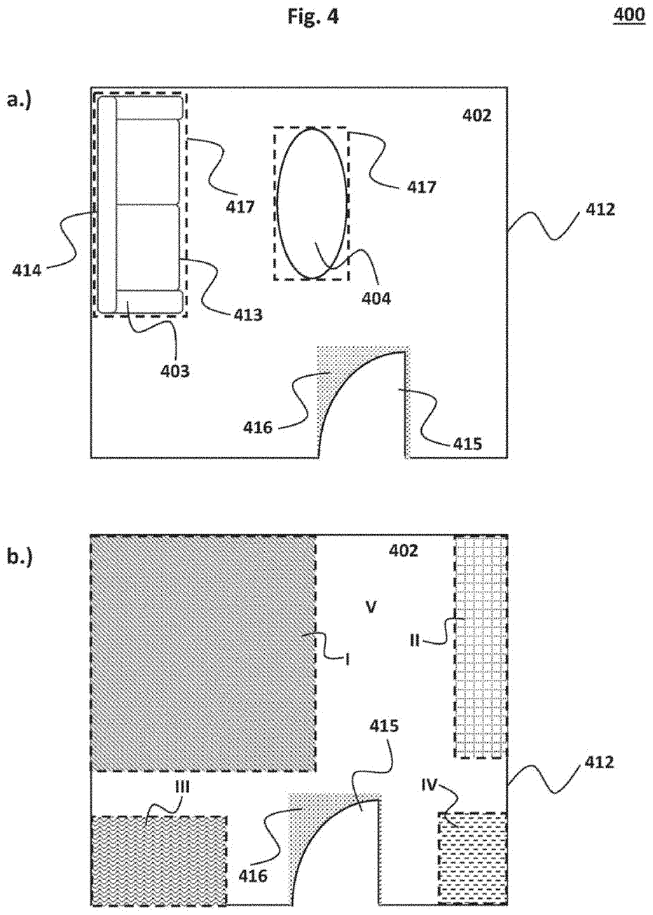

FIG. 4: a schematic illustration showing the determined positions of element sets in the primary representation.

### DESCRIPTION OF FIGURES

FIG. 1 shows an illustration of a visualisation 100. The visualisation 100 is displayed in a visualisation area 101, such as a computer window. The visualisation 100 comprises a primary representation 102 that represents a dining room. Positioned in the primary representation 102 at a first position is a first element set 103 that comprises one first element. The first element represent a dining room table. Positioned in the primary representation 102 at a second position is a second element set 104 that comprises six second elements. Each second element represent a dining room chair. The first elements set 103 has a first interactive component 109, and the second element set 104 has a second inter active component 110. A human operator can interact with the interactive component by, e.g., by clicking with a mouse on the interactive component 110. This results in an information panel 111 being shown to the human operator. The information panel contains information about the item represented by the element, e.g., colour, dimensions, or price. While FIG. 1 only shows two interactive components, the primary representation 201 can contain any number of interactive components.

FIG. 1 further show s that the visualisation 100 has an options panel 105 that is neighbouring the primary representation 102. This options panel has a list panel 106 that contains a list of furniture items that can be represented in the primary representation 102. The list panel 106 allows, e.g., a human operator to change the dining room table being, represented by the first element set 103. The options panel 105 also has a purchase panel 107 allowing a human operator purchase any of the items represented in the primary representation 102. The options panel 105 also has sliders 108, allowing a human operator to adjust, e.g., the resolution or viewing angle of the primary representation 102. The options panel 105 can also contain additional panels for, e.g., messaging.

FIG. 2 shows two examples of the method for producing a visualisation 200. The visualisation 200 has a primary representation 202 that represent a dining room viewed from above. Positioned in the primary representation 202 at a first position is a first element set 203 that comprises one first element. The first element represent a first dining room table. Positioned in the primary representation 202 at a second position is a second element set 204 that comprises six second elements. Each second element represent a dining room chair. The second element set 204 has a second interactive component 210. FIGS. 2.1a and 2.2a show that the second elements are arranged around the first element, and that a distance between each second element and the first element has a first length D.

In FIG. 2.1b, the first dining room table that was represented by the second element set 203 in FIG. 2.1a has been replaced so that the second element set 203 represents a second dining room table that is larger than the first dining room table. This replacement is defined as moving the first element set 203 from the first position to a further position. As a result of the replacement, the first element of the first element set 203 partially overlaps two second elements of the second element set 204. Furthermore, the second interactive component 210 is not visible in FIG. 2.1b. This is not the desired visualisation 202. Note that even if the viewing angle of the visualisation is changed, the first element will still obscure the aforementioned two second elements.

Using the method for of the present invention, the desired visualisation 202 is obtained as shown in FIG. 2.1c. Here the second elements have been rearranged around the first element so that the distance between each second element and the first element has the further length D. The first length and the further length are thus equal. Furthermore, the second element set 204 has been moved from the second position to an even-further position.

In FIG. 2.2b the second element of the second element set 203 has been moved from a first position to a further position. As a result, the first element from the first element set 203 overlaps one second element from the second element set 204. Note that even if the viewing angle of the visualisation is changed, the first element will still obscure the aforementioned second element.

Using the method for of the present invention, the desired visualisation 202 is obtained as shown in FIG. 2.2c. Here the second elements have been rearranged around the first element so that the distance between each second element and the first element has a further length D. The first length and the further length are thus equal. Furthermore, the second element set 204 has been moved from the second position to an even-further position.

FIG. 3 shows a diagram of the steps comprised in the method for producing a visualisation 300. In step 301 a first element set and a second element set is obtained. In step 302 a primary representation of a three-dimensional space is displayed. The first element set is displayed at a first position in the primary representation, while the second element set is displayed at a second position in the primary representation. In step 303, the first element set is moved from the first position to a further position in the primary representation. This causes the second element set to move from the second position to an even-further position in the primary representation. FIG. 4 shows a schematic illustration of the determined positions of element sets in the primary representation 400. In FIG. 4, the primary representation 402 represents a living room. Although FIG. 4 shows the primary representation 402 in two dimensions, this is only for illustrative purposes. The primary representation 402 can be viewed from any angle, e.g., as shown in FIG. 1. FIG. 4 further shows that the primary representation 402 is confined by a boundary 412, which represents the walls of the living room.

FIG. 4 further shows that the primary representation 402 comprises a further element set 415 that represents a door. An exclusion zone 416 is placed around the further element set 415, wherein no element sets are positioned. Any element sets placed by the human operator in the exclusion zone 416 is determined to be outside the exclusion zone 416, i.e., the element set is moved without requiring input from the human operator.

FIG. 4a shows that the primary representation 402 has a first element set 403, representing a couch, and a second element set 404, representing a coffee table. An orientation of the first element set 403 was used to determine its position. I.e., the front of the first element set 413 is not against the boundary 412. A relationship was also established between the first element set 403 and the boundary 412, and the rear of the first element set 414 is adjacent to the boundary.

In FIG. 4a, a relationship has also been established between the first element set 403 and the second element set 404. Furthermore, an optimal distance was determined between the first element set 403 and the second element set 404. The relationship and the optimal distance between the first element set 403 and the second element set 404 was used to determine the position of the first element set 403 and the second element set 404.

FIG. 4a also shows that the element sets 403 and 404, each have a volume 417 that is larger than the volume of the physical item that is represented by the element set. For each of the aforementioned element sets, the volume 417 is a cuboid (a rectangle in the two-dimensional schematic illustration). The volume 417 is thus not determined by the shape of the element set, or the physical item represented by the element set. E.g., The element set 404 is oval shape, while the volume 417 is a cuboid.

FIG. 4b shows how the element set-sizes are used to determine the position of the element sets in the primary representation 402. The total size of the element sets in the primary representation 402 is less than a size of the primary representation 402. The primary representation is divided into five areas. Area I has a seating functionality, and includes e.g., element sets that represent a couch and a coffee table. Area II has an entertainment functionality, and includes e.g., an element set that represents a television. Area III has a storage functionality, and includes e.g., an element set that represents a bookshelf. Area IV has a decorative functionality, and includes e.g., an element set that represents a potted plant. FIG. 4b also show % s the unshaded Area V. This Area V is clear of any element sets, and represent e.g., the space between furniture items that allows a mammal to move between the furniture items.

Test Methods

Unless otherwise stated, all test methods are performed at a temperature of 25° C. and a pressure of 101 325 Pa.

The hardware performance of a computer was measured using the CAM monitoring software. This software is commercially available from NZXT, Inc., USA. This software was used to monitor the load on the RAM. CPU. GPU, as well as the temperature of the CPU and the GPU.

### EXAMPLES

### Example 1

In the below example the visualisation produced according to method of the present invention is compared with producing a visualisation according to prior art. The prior art is the interior design platform Homestyler that is commercially available from Alibaba.com, China.

A primary representation representing a dining room is displayed. Positioned in the primary representation at a first position is a First element set consisting of one first element, wherein the first element represents a first dining room table. Positioned at a second position is a second element set consisting of six second element. Each second element represents a dining room chair. The second elements are arranged around the first element, thus representing the dining room chairs arranged around a first table top of the first dining room chair. Furthermore, the dining room chairs are arranged such that an average distance between the first table top and a back of every chair is 15 cm.

Next, a human operator chooses to replaces the first element, thereby representing the replacement of the first dining room table with a second dining room table. Furthermore, a second table top of the second dining room table is larger than the first table top. With the method for producing a visualisation according to the present invention, the second elements are rearranged around the new first element, thus representing that the dining room chairs are arranged around the second table top. Furthermore, the dining room chairs are arranged such that the average distance between the second table top and a back of every chair is 14.97 cm.

In order to produce the same visualisation using a method according to the prior art, the human operator first has to switch to a further visualisation showing a floor plan of the dining room. In this floor plan, the first element is removed, creating an empty area between the second elements. The latter then have to be moved individually in order to enlarge the empty area. The first element, now representing the second dining room table, is added to the floor plan. The second elements then have to be arranged individually around the first element. Once this is completed, the visualisation of the room can be produced using the updated floor plan. Note that if the empty area is not enlarged, then the replacement of the first element will lead to the first element at least partially covering the second elements so that these elements appear to be part of each other.

TABLE 1
advantages of the present invention over the prior art.

| | Present | Prior |
|---|---|---|
| | invention | art |
| Time needed to produce | 2 | 600 |
| visualisation (seconds) | | |
| Elements are obscured (e.g. overlap) | No | Yes |
| Visualisation updated in real time | Yes | No |
| Viewing angle of visualisation | Yes | No |
| can be changed | | |
| Resolution of visualisation | 4096 × 4096 | 2560 × 1440 |
| Training required to | No | Yes |
| produce visualisation | | |
| How accurate is the visualisation | Very high | High |
| compared to room represented | | |
| Energy consumption | Less | More |
| Computer resource usage | Low | Moderate |
| Production material wasted | Less | More |
| Productivity of physical items | More | Less |
| Production speed | Higher | Lower |

In the above table. “energy consumption” refers to the electricity used by computer when the visualisation is produced. This consumption is reflected in the heat generated by the CPU or GPU. The “computer resource usage” refer to the load on the CPU, RAM, and GPU.

The visualisation can also be used to provide producers of items, such as furniture and decorative items, an idea of the type and number of items they should produce. Therefore less “production material” is wasted as less unwanted products are produced. Furthermore, the number of items also allows a producer to optimise the production process to produce items that are in higher demand, thereby increasing the number of items that can be produced (“productivity”), as well as the “production speed”.

### Example 2

Data is collected from previous users that interact with a visualisation. This data includes the types of physical items, e.g., chairs, tables, and plants, that are chosen by the users for display in the primary representation. This data also includes further information regarding the types of physical items, e.g., the colour of the item, the material that the item is made off, the size of the item, chosen by the users for display in the primary representation. This data also includes the position where a user chooses to display the physical items in the primary representation. This data also includes the combination of physical items that the user chooses to display in the primary representation. This data also includes the combination of the positions of the physical items, as chosen by the user for display in the primary representation.

The collected data is analysed to obtain analysed data. Based on the analysed data, any of the following is suggested to the user for display in the primary representation: physical items, combinations of physical items, physical items that have specific characteristics, combinations of physical items that have specific characteristics. Based on the analysed data, any of the following is also suggested to the user: the physical items (or their element representations) are placed at positioned determined by the analysed data.

When the user modifies or accepts the suggestions, this is collected as further data. For example, the user may move an element from a suggested position in the primary representation to another position in the primary representation. Or a user may add an additional element that was not suggested. The collected further data is then analysed, together with the collected data, to obtain analysed further data. The analysed further data is then used to make suggestions to further users that interact with the visualisation.

Producing a visualisation according to the invention, wherein analysed data and analysed further data is used to produce the visualisation, has many technical advantages over not using data for producing a visualisation. E.g., by pre-rendering or pre-loading item popularly selected by user for display in the primary representation, the amount of CPU, memory and network resources are reduced.

Producing a space according to the invention, wherein analysed data and analysed further data is used to produce the space, has many technical advantages over not using data for producing a space. Examples of a space are furniture showroom or a storage space of retailers. Examples of the advantages are the following: producers of items, such as furniture and decorative items, are provided an idea of the type and number of items they should produce. Less production material is thus wasted as less unwanted products are produced. Furthermore, a producer can optimise the production process to produce items that are in higher demand, thereby increasing the number of items that can be produced, as well as the production speed. Furthermore, the usage of the available space in, e.g., a storage space, can be optimised. Furthermore, when producing a space, more popular items can be arranged in larger areas, and less popular items in smaller areas. This improves the safety of the people in the space, as a congestion of people in an area can be avoided.

### REFERENCE LIST

100 Example of a visualisation
101 Visualisation area
102 Primary representation
103 First element set
104 Second element set
105 Options panel
106 List panel
107 Purchase panel
108 Sliders
109 First interactive component
110 Second interactive component
11 Information panel
200 Example of the method for producing a visualisation
202 Primary representation
203 First element set
204 Second element set
210 Second interactive component
300 Method for producing a visualisation
301 Obtain first element set and second element set
302 Display primary representation, first element set, and second element set
303 Move first element set
400 Determined position of element sets in primary representation
402 Primary representation
403 First element set
404 Second element set
412 Boundary
413 Front of first element set
414 Rear of first element set
415 Further element set
416 Exclusion zone
417 Volume of element set

1. A computer implemented method for producing a visualisation, comprising the steps of
a. obtaining
i. a first element set, wherein the first element set has a first volume,
ii. a second element set, wherein the second element set has a second volume;
b. displaying
i. a primary representation of a three-dimensional space,
ii. the first element set at a first position in the primary representation,
iii. displaying the second element set at a second position in the primary representation, wherein a distance between the first position and the second position has a first length;
c. moving the first element set from the first position to a further position in the primary representation, wherein
i. the moving of the first element set causes the second element set to move from the second position to an even-further position in the primary representation,
ii. the distance between the further position and the even-further position has a further length, wherein the first length and the further length vary with less than 5% with respect to each other,
iii. wherein less than 5% of the first volume overlaps with the second volume.

2. The method according to claim 1, wherein the even-further position is determined by calculating at least one or all of the following: at least one force, at least one energy, at least one mass, at least one distance, at least one orientation, and at least one hierarchy.

3. The method according to claim 1, wherein the even-further position is determined by calculating at least one or all of the following:
a. a repulsive force;
b. a first attractive force.

4. The method according to claim 1, wherein at least one or all of the following is determined by calculating a further attractive force: the first position, the second position, the further position, and the even-further position.

5. The method according to claim 1, wherein the method further comprises the step of establishing a relationship between the first element set and the second element set.

6. The method according to claim 1, wherein the visualisation is produced on at least one or all of the following:
a. a device of a user;
b. a server.

7. The method according to claim 6, wherein the visualisation is produced on the server if the visualisation fails to be produced within a specified time limit on the device of the user.

8. The method according to claim 1, wherein the visualisation is produced using at least one or all of the following:
a. a game engine;
b. an application programming interface (API).

9. The method according to claim 1, wherein the visualisation is produced using augmented reality software.

10. The method according to claim 1, wherein the method further comprises at least one or all of the following steps:
a. changing the resolution of the visualisation,
b. calculating an illumination of the visualisation.

11. The method according to claim 1, wherein the visualisation is displayed via a display device selected from the group consisting of a screen, a video projector, a holographic projection device, an augmented reality device, a virtual reality device, or a combination of two or more thereof.

12. The method according to claim 1, wherein at least one element represents at least one physical item.

13. The method according to claim 1, further comprising the step of collecting data about at least one or all of the following: the first element set, the second element set, at least one further element set, and a combination of at least two or more thereof.

14. The method according to claim 13, further comprising the step of analysing the collected data to obtain analysed data.

15. A visualization obtainable by the method according to claim 1.

16. A data processing device comprising means for carrying out the method according to claim 1, wherein the data processing device comprises at least one or all of the following:
a. at least one processing unit;
b. at least one display device;
c. at least one network card;
d. at least one input device;
e. at least one graphics processing unit;
f. at least one storage medium.

17. A computer program comprising instructions which, when the program is executed by a computer, causes the computer to carry out the method according to claim 1.

18. A computer-readable data carrier having stored thereon the computer program of claim 17.

19. A first method for producing a space comprising at least one physical item, wherein the position of the at least one physical item in the space is determined using the method for producing a visualisation according to claim 1.

20. A second method for producing a space comprising at least one physical item, wherein the method comprises the steps of
a. obtaining
i. a first element set,
ii. a second element set;
b. displaying
i. a primary representation of the space,
ii. the first element set in the primary representation, and
iii. the second element set in the primary representation;
c. collecting further data about at least one or all of the following:
i. the first element set,
ii. the second element set;
d. analysing the collected further data to obtain analysed further data;
e. producing the space;
wherein
either a position, at least one characteristic, or both, of the at least one physical item in the space is determined by the analysed further data.
